(19) United States
(12) Patent Application Publication
(10) Pub. No.: US 2010/0293147 A1
(43) Pub. Date: Nov. 18, 2010

(54) SYSTEM AND METHOD FOR PROVIDING AUTOMATED ELECTRONIC INFORMATION BACKUP, STORAGE AND RECOVERY

(76) Inventors: Harvey Snow, Los Angeles, CA (US); Howard Arthur Schechtman, Agoura Hills, CA (US)

Correspondence Address: CHRISTIE, PARKER & HALE, LLP, PO BOX 7068, PASADENA, CA, 91109-7068, US

(21) Appl. No.: 12/777,189

(22) Filed: May 10, 2010

Related U.S. Application Data
(60) Provisional application No. 61/177,460, filed on May 12, 2009.

(51) Int. Cl. G06F 17/30

(52) U.S. Cl. 707/640; 707/E17.007

(57) ABSTRACT

An automated electronic information backup, storage migration, and recovery system includes techniques for automatically observing all file events over a plurality of computing devices. The observed file events are mapped to the applications producing them. A relevancy of those file events are determined based on an application information repository. Business rules are produced based on this information to automatically backup all relevant file event changes and restore or migrate backed up information when necessary.

### CROSS-REFERENCE TO RELATED APPLICATIONS

This application claims the benefit of U.S. Provisional Application No. 61/177,460, filed on May 12, 2009, the content of which is incorporated herein by reference.

### FIELD OF THE INVENTION

The present invention relates generally to data backup and retrieval, and more particularly, to a system and method for automatically and optimally backing up and restoring program and data files across a plurality of computing devices.

### BACKGROUND OF THE INVENTION

Conventional software techniques for backing up and restoring program and data files do so primarily by observing changes to program and data files and storing the delta of those changes to some backup medium.

However, these conventional techniques provide little or no automated help in determining what data or program files are actually important to backup. Conventional techniques for backup are generally not aware of the characteristics of the applications that produce and store data and therefore cannot select and optimize the data that needs to be backed up. Conventional techniques for backup do not have self-learning mechanisms that can be applied to produce policies for persisting data and files.

In a typical enterprise environment today there is a multiplicity of separate applications that are needed to fulfill the totality of an enterprises' business functions. Each of these applications has its own data store, configuration information, and business rule data sets.

Often, the locality of this information spans multiple computing environments and physical locations, as well as workstations and server platforms. In addition, the ownership of and update capability for these separate information sets may be dispersed, and/or duplicated across the enterprise to different departments and/or individuals.

This makes it difficult if not impossible to centralize change management for the entirety of the data, or to even understand the interrelationship and effect of the myriad of separate and discrete file events to the data.

It is this aggregate of different applications and their related data sets that make up the operational set of information that an enterprise generally depends upon to perform its daily business. It is also this aggregate of information that must generally be backed up and recovered in case of failures that result in information loss.

The issues that arise for an enterprise is that the disparate nature of these separate applications and the potential complexity of each application and its data, make it very hard for an enterprise to understand what data it is dependent upon, what data it needs to archive, and what dependencies there are between applications.

Furthermore, in complex enterprise environments, there are application files, configuration information, and data files that may be duplicated across the same or multiple computing devices, and that should be backed up only once and not redundantly backed up for each instance in the source file system.

In short, getting a business “up and running” after a disaster recovery is not just an issue of restoring transactional databases, but also includes restoring the related files and configuration information related to business processes that contribute to a fully operational enterprise.

Further, as the technology landscape becomes increasingly more sophisticated due to its interconnected and co-dependent systems of information, it becomes increasingly more difficult to audit or restore what the information landscape actually looked like at any moment in time. This is true, not only in terms of the data that exist within an organization's business environment, but also in relation to the various computer programs that run within an environment which share instructions, configurations, and other resources which have their ‘state’ contained in files.

Given the current landscape of tools, it is potentially impossible to reconstruct a moment of time. For example if a doctor in a medical practice is accused of mal-practice, but in fact, did what was ordinary and standard, this would be difficult to establish based on the information available,. It is desirable, however, for such a reconstruction to take place.

Three example scenarios are listed here to further illustrate some of the challenges.

Forensics: In order to restore a system to a particular moment in time in order to conduct an investigation for regulators, or to gain insight into a prior state in a system of information, in order to make plans for the future.

Restoration & Disaster recovery: In order to restore a system to a particular state when a user's component fails and needs state for other components in order to function properly.

Resolving problems when one user clobbers the file of another user: Understanding exactly what changed in our complex environments is hard, or impossible to accomplish.

As the community becomes a global network of interconnected businesses in custody of each other's data, the need to solve these problems in a reliable, efficient, and secure manner, is increasingly urgent.

In the current landscape, even corporations with vast resources and regulatory requirements that would enable them to do this, generally cannot. Such corporations often spend millions of dollars per application to allow for audits and recovery from disaster to take place, but even then, they often cannot return to a particular state and prove what information they had at a particular moment, and even then, they cannot recover to a particular state if an application fails, and dependent applications must generally roll back to accommodate a recovery.

Prior art is inadequate to solve the various problems in back up and recovery of files. Thus, there is a need for:

The ability to listen for cross platform file events

The ability to compress files based on the difference between current and new file versions when these files are on the computer where they originated, thus sparing the network and the I/O channels of the computer of unnecessary burdens of transporting unnecessary data.

The ability to allow the user to create a tag cloud establishing the metadata around the files in order to create arbitrary systems of files. Some attempts to allow for hard wired structures of files to be created do exist, but they are not capable of sufficient user definition to be able to solve the problems specified above.

The ability to use a business rules engine to allow users to create complex patterns to manage files, and for the implementer of this solution to partner with vendors and quickly go to market with end to end solutions for complex distributed back up, and recovery schemas.

The ability to create federated administration of the ‘meta definitions’ of the networks of files.

The ability to create automated policy dispute resolution.

### SUMMARY OF THE INVENTION

The present invention is directed to a computer apparatus and method for data backup and recovery across a data communications network. The computer apparatus stores program instructions in its memory which, when executed by a processor, allow the detection of a file change for a file. The file change may be a change of file metadata and/or change to payload contents of the file. In this regard, the processor monitors file events and discovers computer applications associated with the monitored file events. The processor identifies a computer application producing the file change and retrieves from a rule repository one or more backup rules stored in association with the identified computer application. In doing so, the processor may identify a usage domain for the computer applications and select the set of default backup rules based on the identified usage domain. The processor may also identify customized backup rules.

The processor determines, based on the retrieved backup rules, whether the file change, or information about the change, should be stored in a backup repository. If it determines that the file change should be stored, it transmits the file change over the data communications network. In this regard, the processor transmits a block of data in the file containing the file change without also transmitting a block of data that has no file changes. A unique copy of the file change is then stored in a remote backup repository.

According to one embodiment of the invention, the file change may be identified in real time with the occurrence of the change. Such real time identification entails identifying by the processor a process identifier of a computer process producing the file change, and mapping the process identifier to the computer application. In this manner, the backup rules stored for the particular computer application are identified and retrieved.

According to another embodiment of the invention, the file change is identified “post-mortem” after the file change has occurred. In this regard, the processor periodically scans a data storage device storing the file and identifies changes in metadata for the file. In order to identify the computer application that caused the file change, embodiments of the present invention compare a path of the file to a rule associating the file to a particular application. Other metadata about the file, such as, for example, the user that created or modified the file, may be used to make associations between the file and a particular application.

In either the real-time or post-mortem embodiment, the determination as to whether a file change should be stored in the backup repository depends on the backup rules retrieved for the application that caused the file change. In this regard, backup criteria are identified from the retrieved backup rules and a determination is made as to whether the backup criteria have been satisfied. The backup criteria may relate to resources available, file metadata, event time, user information, and the like.

According to one embodiment of the invention, the determination as to whether a file change should be stored in the backup repository includes generating a hash value of a block of data contained in the file. The processor determines, based on the generated hash value, whether the block of data in the file differs from a corresponding block of data stored in the backup repository. The processor then tags the block of data in the file if it differs from the corresponding block of data in the backup repository. In this manner, redundancy in the data that is stored in the backup repository is avoided.

According to one embodiment of the invention, the processor restores systems of files stored in the backup repository in response to a user command which may include one or more restore parameters. Upon receipt of the command, the processor identifies a computer device into which the systems of files are to be restored, and proceeds to restore the file onto the identified computer device according to the restore parameters. The identified computer device may be the device that contained the original file, or some other device identified by the user.

In restoring an individual one of the systems of files onto the identified computer device, a repository server makes use of data stored in a metadata repository to identify one or more blocks of data associated with the file that is to be restored, and retrieves each of the one or more blocks of data from the remote backup repository. The file is then re-created based on the retrieved one or more blocks of data and stored in the identified computer device.

According to one embodiment of the invention, the backup rules may be customized by a user. In this regard, the processor generates a set of customized backup rules in response to customization parameters provided by the user via a graphical user interface, and stores the set of customized backup rules in the rule repository.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a block diagram of a backup, migration, and recovery system according to one embodiment of the present invention;

FIG. 2 is a more detailed block diagram of main software components of computing devices in the system of FIG. 1 according to one embodiment of the present invention;

FIG. 3 is a flow diagram of steps taken during an installation and configuration phase according to one embodiment of the present invention;

FIG. 4A is a flow diagram of steps taken during a file recovery phase of according to one embodiment the present invention;

FIG. 4B is a conceptual diagram of how a user creates file restoration scenarios or computer system restoration scenarios according to one embodiment of the invention;

FIG. 4C is a screen shot of a GUI allowing a user to make choices controlling complexity of a restore scenario according to one embodiment of the invention;

FIG. 4D is a screen shot of a GUI allowing a user to pick source computers for a scenario according to one embodiment of the invention;

FIG. 4E is a screen shot of a GUI that allows users to map which directories are of interest to them, and which directories will receive restored or migrated data, according to one embodiment of the invention;

FIG. 4F is a screen shot of a GUI for allowing a user to eliminate files according to one embodiment of the invention;

FIG. 4G is a screen shot of how a user is able to both set a service level agreement for how long a restoration would take place, and plan for when the restoration is to take place, and from what time the last back up will be according to one embodiment of the invention;

FIG. 5 is a flow diagram of steps taken during a file archive phase according to one embodiment of the present invention;

FIG. 6 is a flow diagram of steps taken during proactive observation of file events to enforce compliance with a user defined business rule according to one embodiment of the present invention;

FIG. 7 is a flow diagram of steps taken to migrate a file according to one embodiment of the present invention;

FIG. 8 is a conceptual layout diagram of an application information repository according to one embodiment of the present invention;

FIG. 9 is a conceptual layout diagram of a business information repository of according to one embodiment the present invention;

FIG. 10 is a conceptual layout diagram of a metadata storage vault according to one embodiment of the present invention; and

FIG. 11 is a conceptual layout diagram of how file data is stored on a source disk and a file vault, and how file versions are referenced in a metadata repository according to one embodiment of the invention.

### DETAILED DESCRIPTION

Embodiments of the present invention provide a system and method for enterprise data backup, migration, and recovery through a three-phase process that includes:

1. Discovery

2. Backup (or observation)

3. Recovery (or migration)

The discovery phase facilitates the enterprise in knowing the totality of its data complexity and data backup needs.

The backup, migration, and recovery system according to embodiments of the present invention discovers an enterprise's data backup needs through a combination of automated discovery of file events; the mapping of these file events to applications; and both automated and manual methods for deciding which file events are significant and therefore should lead to the setting up of business rules to facilitate the automated backup of the relevant data.

According to one embodiment, the system employs three main mechanisms during the discovery phase:

1. File event monitoring and application mapping

2. File event relevance determination using an application information repository

3. Business rules creation for backing up files

File event scanning and application mapping are accomplished using kernel level device drivers inserted in between an application layer and an I/O layer of an operating system of a backup, migration, and recovery source computer. A file event scanner in the source computer observes which file events map to which process IDs. Based on this knowledge, the source computer maps which applications are creating the files and their events. Also provided is a tool to observe the installation of software, and to automatically map these installations to a business application, based on a business rule, and then populate metadata with a list of new programs to associate with that business application. This allows for a reduction in the efforts an enterprise has to make in order to understand what must be backed up.

After the file events that have been mapped to applications are discovered, the file events are automatically compared against an application information repository. The application information repository is a repository of information, built up over time and within various vertical industries (e.g. Health Care, Finance etc.). It contains, for each of the vertical industries, information and business rules on a per application basis about relevance of different types of file events which are used for data backup and recovery. The application information repository allows subsequent enterprises to leverage industry knowledge about the typical interdependence of applications in their vertical space, which allows for quicker and more accurate business rules to be written controlling the backup and recovery of data across applications. It allows for a set of default rules to be in place for unsophisticated organizations without the operational expertise to craft these rules on their own.

The output of these two automated steps are then used, along with enterprise business experts, to construct the business rules necessary to drive the data backup phase. In the data backup phase, the system uses the business rules created in the discovery phase for performing data backup. A file event monitoring software in the source computer watches file events in real time, caches file block differences based on those rules, caches those backup blocks locally, and then ultimately transmits those backup blocks to a remote computing-based backup repository such as, for example, a cloud computing environment. Data is encrypted at the source computer using enterprise owned keys before the data is ultimately transmitted to the remote computing-based repository. According to one embodiment, only the enterprise holds the keys necessary to successfully decrypt their data.

An embodiment of the invention creates a set of back up business rules that only observe what files have changed as opposed to backing up these files. The power of this for the enterprise is a bottom up change management record. This might be especially useful in the case that the computer programs and configurations themselves come from a change management system and thus do not need to be backed up. Often, when problems arise, the technology staff of an organization can spend man weeks simply working to understand exactly what has changed. The ability to quickly get a change report across a range of systems that are backed up using the various embodiments of the present invention is powerful for problem resolution.

The backup phase also follows best practices regarding event caching as well as resource-awareness as to when it is allowable to do CPU-intensive work like encryption or network-intensive work like transmission of backup data.

Another example of resource awareness is the system's ability to ensure that data is not backed up more than once. This is done on the source machine utilizing an industry standard check sum technology along with the addition of a proprietary file size to which composes a proprietary check sum. This avoids the need for the currently oft-deployed bit wise comparison of identical resources to ensure that unique files are never missed. A user may choose to do a bit wise comparison, but the system makes this task statistically redundant.

The system makes used of the data recovery phase to restore a single file or an entire enterprise data environment. The data recovery phase is controlled by the enterprise through a GUI dashboard that allows the enterprise control of when and how much data is to be recovered. A recovery may be to the machine where the data originated, or different machines. It may take place once in order to respond to a one time need, or it may take place on an ongoing basis in order to migrate the files that compose an application environment to stand by environments that are ready on a moment's notice to take over in the case of a disaster.

The system in the data recovery phase accesses encrypted data that is saved in the remote computing-based repository, and moves and stages that data back to the relevant enterprise computing platforms (workstations and or server platforms). The system then decrypts the data on the platform of origin using the enterprise owned encryption keys and then finally restores the files to the operating file system, keeping intact the metadata concerning such things as visibility, security, and ownership, allowing the files to be used by the enterprise's business applications as per expectations. According to one embodiment of the invention, the provisioning of computers with their symmetric keys is automated according to conventional mechanisms.

If the data has to cross security zones within an enterprise, then a negotiated session key allows for this to take place. In this way, data can cross security zones where different keys are used, without the storage infrastructure where the data is archived ever seeing the data in the clear.

The backup, migration and recovery system according to embodiments of the present invention ‘continuously recover’ state changes from one environment to another in a platform independent manner. This allows for the migration of data from one environment to another. A migration scenario is created, which stipulates how often changes are to be transferred from, for example, a production environment for an application, to continuity of business environment.

The advantage that this technique employed by the embodiments of the present invention, has over similar schemas of replication at the disk level, is that, according to one embodiment, only those files that are necessary to compose the recovery environment are migrated. The scenario can be composed so that although entire disks do not have to be migrated, an entire environment's files including programs, configuration, and data can be held in two environments. These migration techniques can also be used to refresh a test or development environment with master data from a production system.

The advantage that this technique employed by the embodiments of the present invention, has over similar schemas of replication at the logical level, for example, log shipping replication schemas in the relational data base industry, is that those schemas are customized per database via proprietary computer programs that do this work, and intense user customizations in order to configure those tools on a per application basis. The present system provides the advantage that logical replication is accomplished without the need for a high degree of customization for an application vendor or an application user.

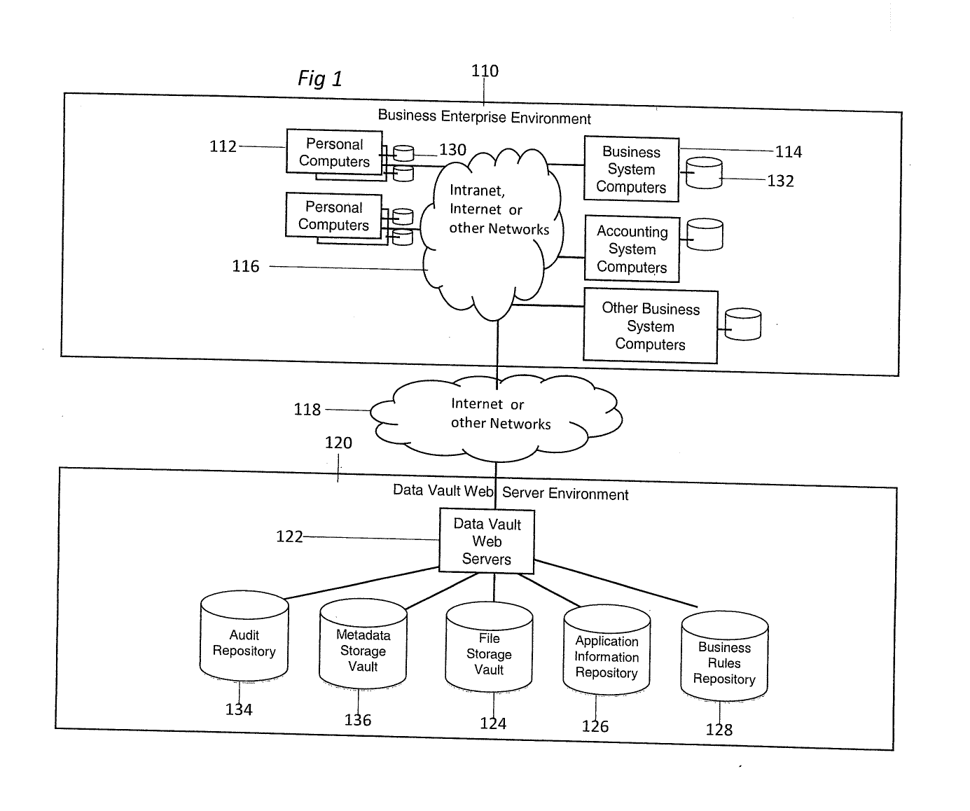

FIG. 1 is a block diagram of a backup, migration, and recovery system employed by a business enterprise according to one embodiment of the present invention. The system in FIG. 1 includes a business enterprise environment 110, a data vault web server environment 120, and a communication network 118 interconnecting the two environments. In one embodiment of the invention, the data vault web server environment 120 is a cloud computing web server environment.

The business enterprise environment 110 includes a plurality of computing systems used by the business enterprise. The computing systems include both personal computers 112, and business system computers 114. The personal computers 112 and business system computers 114 are interconnected via a communications network 116. The various types of personal computers 110 include but are not limited to Windows based personal computers, laptops, notebooks, Macintosh computers, smart phones, netbooks, and the like. The personal computers 112 are either directly or network connected to persistent file storage devices 130 which include, but are not limited to, disk storage devices, solid-state storage devices, storage area networks, and network attached storage systems. The business system computers 114 are either directly or network connected to persistent file storage devices 132 which include, but are not limited to, disk storage devices, solid-state storage devices, storage area networks, and network attached storage systems.

The personal computers 112 and the business system computers 114 in the business enterprise environment 110 are configured to create and modify files that are stored onto the various file storage devices 130 and 132. The files may be backed up, based on business rule policies, either to the local business enterprise environment 110 or the remote data vault web server environment 120. The files may further be restored, based on business rule policies, from either the local business enterprise environment 110 or the remote data vault web server environment 120.

The data vault web server environment 120 includes but is not limited to data vault web servers 122, data storage vault devices 124, metadata storage vault devices 136, an audit repository 134, an application information repository 126, and a business rules repository 128.

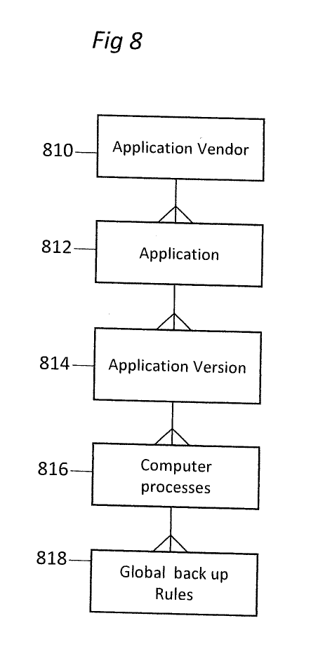

The application information repository 126 contains pre-defined global or default business rules for each computer application for backing up files generated by that application. According to one embodiment of the invention, the rules in the application information repository 126 are organized by application vendor and application name. FIG. 8 is a conceptual diagram of the organization of the application information repository 126 according to one embodiment of the invention. These rules are pre-defined based on previous research and ongoing experience for well-known applications used in a domain. For example there can be predefined business rules for backing up files for Epic, which is a commonly used application in the Health Care Industry. In this regard, the application information repository may store default rules for a plurality of vertical industries (usage domains), such as for example, healthcare, financial, and the like. Although some of the same applications may be used by the various industries, the backup needs for data generated by those applications may vary depending on the type of industry. Embodiments of the present invention allow default rules to be stored on a per industry basis so that a particular enterprise may select the default rules applicable for its industry, and further, add custom rules catered specifically to the particular enterprise.

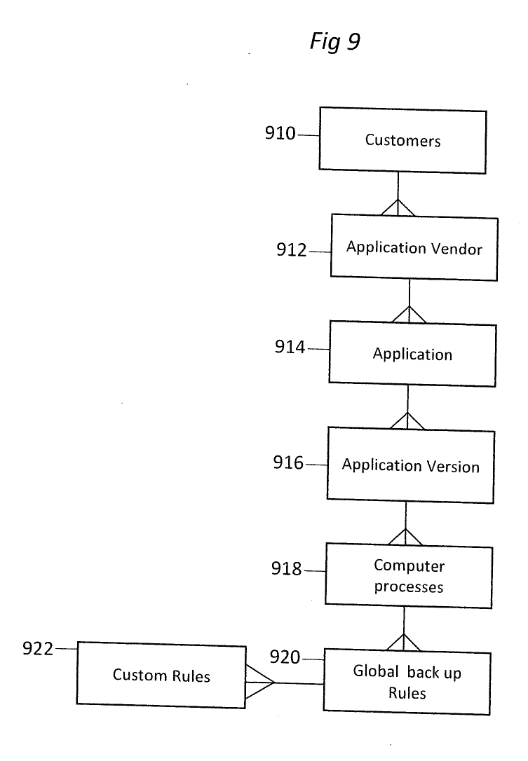

The business rules repository 128 contains the specific business rules for each computer application that a specific customer might use. According to one embodiment, the rules in the business rules repository 128 are organized by customer. So far example the actual business rules per application that Kaiser Permanente might use for Epic are persisted in the business rules repository 128. FIG. 9 is a conceptual diagram of the organization of the business rules repository 128 according to one embodiment of the invention. Furthermore in one embodiment of the invention, when the customer chooses to use the default business rules for an application, the record for the rule in the business rule repository 128 will point to the application information repository 126 and will not be duplicated in the business rules repository 128.

The communications network 118 interconnects the business enterprise environment 110 and the data vault web server environment 120. The types of communications network 118 interconnecting the two environments include but are not limited to the Internet and other networks.

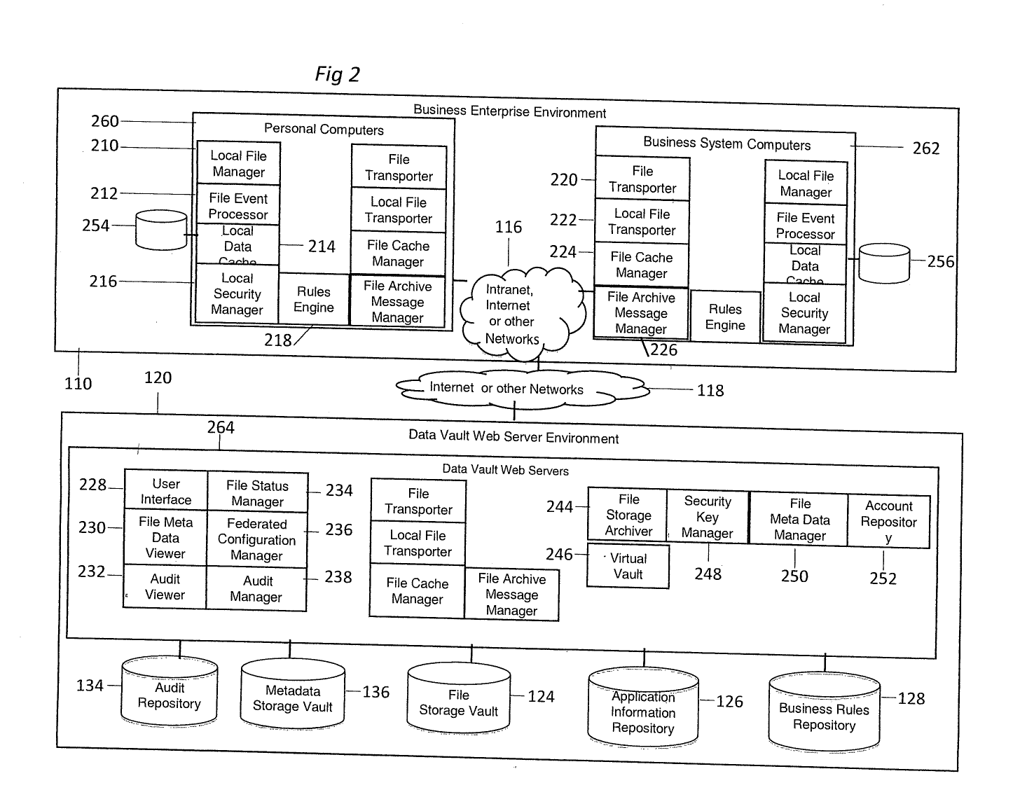

FIG. 2 is a more detailed block diagram of the main software components of various computing devices 260, 262, 264 of the system according to one embodiment of the present invention.

According to one embodiment, the software components that reside in the business enterprise environment 110 on both personal computers 260 and business system computers 262 include, but are not limited to, a local file manager 210, a file event processor 212, a local data cache 214, a local security manager 216, a rules engine 218, a file transporter 220, a local file transporter 222, a file cache manager 224, and a file archive message manager 226. The personal computers 260 and business system computers 262 may be similar to the personal computers 112 and business system computers 114 of FIG. 1. These computers include one or more processors and memory. The memory includes computer program instructions which, when executed by the processor(s), provide the functionality of the software components described herein.

According to the embodiment of FIG. 2, the local file manager 210 interprets file events, and based on business rule policies stored in the business rules repository 128, determines if files should be archived or not. If files are to be archived, the local file managers manages this process by: globally de-duplicating the file; encrypting the file; optimizing the file's transmission to the data vault web server environment 120; transporting the file to the data vault web server environment 120; optionally caching a local of the file, in accordance with the business rules; and persisting the state of the current activity in case a crash of the system.

According to one embodiment of the invention, there are two primary ways in which files are identified as being files of interest and therefore candidates to be backed up according to either global backup rules or custom backup rules. These two ways are: (1) real-time observation of file changes; and (2) post-mortem disk-scan discovery of file changes. The post-mortem backup embodiment entails backup of files of an entire disk on a periodic basis, as opposed to backing up each file substantially contemporaneous with the occurrence of a change in the file, as would be done in the real-time backup embodiment.

The real-time observation of file changes include: (a) an initial observational monitoring of file events by the personal and business system computers in order to discover applications producing files; (b) using the application information repository 126 and business information repository 128 to determine which of the discovered applications are of interest; (c) further using the application information repository 126 and business information repository 128 to find either the global or the custom backup business rules to be used for files produced by this application; and (d) performing the real-time observation file change and real-time backup of files based on the global and or custom backup business rules.

The post-mortem disk-scan approach to discovering file changes include: (a) an initial observational scan of file events by the personal and business system computer in order to discover changes to the file system from its last known state; (b) using the application information repository 126 and business information repository 128 to determine which of the discovered files are of interest; (c) further using the application information repository 126 and business information repository 128 to find either the global and or the custom backup business rules to be used for files produced that are changed; and (e) replacing (d) above (real-time observation) with a periodic post-mortem scan of disk to deduce what files have to be backed up and post-mortem backing up of those files based on the global and or custom backup business rules.

The post-mortem disk-scan approach identifies what directory path a file lives at and the name of that program would have created this file change is inferred based on other meta data available from the file system and by combining this knowledge with the names and directory paths of the files that an application produces. By comparing the directory path and name combination, along with other meta data as required, to a rule set the local file manager 210 may then identify files that have been produced by applications for which backup rules exist. The rule set may map a file to an application based on the name of the file and other metadata, such as, for example, the person generating the file. Such a rule may read:

If FileName==EMR.ora, and FileOwner==GeAdmin then application=GEHealthERM,

The backup rule for such application might then be:

If application==GEHealthERM and if last backup>1 hour, then HIPAAFLAG=1

In either the real-time or post-mortem approach, once a file is identified as having been produced by an application, and being of interest then in the rule engine, the computer device retrieves a relevant business rule which may stipulate something like “If application is EpicEMRSystem, then HIPAA flag=1,” which signals that the file should be backed up. More complex rules can be created around the fact that a file is produced by an application. For example:
If the file is a configuration file, it can be tagged ‘configuration file’ or likewise if it is a data file’ it can be tagged ‘data file’ etc.
If the file is a computer program, it might be that it should be tagged as such but only observed.
If the file is produced by one user, and not another, the file might be backed up observed etc.
If the file was backed up within an hour, it might be ignored

In either the real-time or post-mortem scan approach, system provides tools that allow a customer to customize the rules about a file that the local file manager 126 understands. For example, if the default location for data files is in one place, but a business deploys the file such that the data files are placed in another place, a business can ‘clone’ the default rules, and change the path to which files are written. Once the personal or business system computer 260, 262 that hosts the computer program belonging to the application is identified in the discovery phase of deployment, the system does the following:
Looks to see if a custom rule exists, if it does then this custom rule is deployed to the node hosting the application
If no custom rule exists then the global rule is deployed

According to an embodiment of the invention, the system is configured to capture a level of surety that it is backing up the files that it should. At a lowest or least certain level of surety, the user (customer) may assert that it understands that the application rules are correct. At a middle level of surety, the vendor of the present invention, which manages the global rules, may assert that the application finder will correctly identify the files. At a highest level of surety the application vendor, of the business application may assert that the application finder will do its job correctly. This allows an auditor, reporting on compliance with a service level agreement that a backup has successfully taken place, to trust the assertion of the system at increasingly sure set of levels, and allows application vendors of business applications to outsource the responsibility to back up its applications if they wish to.

The local file manager 210 is further configured for: restoring files with proper meta data; accepting migrated files and instantiating them with the proper meta data; managing keys for other nodes as requested; managing the file event processor 212 and local components either by encapsulation or network communications via a web service; reporting anomalies and security threats to the data vault web server environment 120; throttling itself and other local components based on business rules; receiving and storing business policies administered by the system; observing and reporting on changes to the file system as per the business rules, even when those files are not archived; and discovering unknown applications and reporting them to the administrators for the customers and data vault operational staff.

With continued reference to FIG. 2, the file event processor 212, is a stateless component that sits between the I/O system and the file system, mapping all file events to process identifiers that cause the file events, and reporting on all activity to the local file manager. The local file manager 210 manages this component. The file event processor 212 may be broken down into two parts: (1) a system service; and (2) a event processor. According to one embodiment, the system service manages a device driver which listens to the events. The event processor executes primitive rules, and acts as a messenger to the local file manager 226 in order to filter out extraneous events to spare the local file manager the burden of doing this work. According to one embodiment, the file event processor 212 is the only local component that is platform dependent.

According to one embodiment of the invention, the local data cache 214 is a reserved local storage repository composed of disks, SAN, disk array, etc, which may be mounted to a network attached device which the system uses to store files that are being processed, or must for some business reason be immediately available but not in the place where the files would be if they were restored.

According to one embodiment of the invention, the local security manager 216 manages SSL, PKI, encryption, decryption, a key store, and performs other security event management on the local components. According to one embodiment, the local security manager is part of a deployment profile, generating private keys, symmetric keys, hiding root passwords for databases, and the like. It operates at runtime in order to secure the local environment from unauthorized use, and to report attacks to the cloud server, which manages any security threats.

According to one embodiment of the invention, the file transporter 220 is an abstract component realized by three instantiated components: the local file transporter 222, the file archive message manager 226, and the file cache manager 224. These components collaborate to provide the message backbone of the system.

According to one embodiment of the invention, the file transporter 220 is responsible for transporting files from one network node to another. The file transporter 220 has a low level awareness of the task it is doing in relation to the rule based importance of that task, and is configured to prioritize the work it does based on the availability of resources to do this work.

According to one embodiment of the invention, the local file transporter 222 packages messages and ships them to the next node on the network, either a file cache manager 224 or a file archive message manager 226. For each computer being managed, one of these components will be instantiated.

According to one embodiment of the invention, the file cache manager 224 is an optional component used to enhance performance of file restorations which caches file packages and transports them to another file cache manager 224 or to a file archive message manager 226. The file cache manager 224 manages any local file transporter nodes that it is responsible for. In order to provide a fault tolerant scenario requiring redundancy, and to potentially enhance the speed of file recovery within a local area network, a secondary file cache manager 224 communicates with all other nodes managing the local file transporter 222 to keep state consistent among the caching nodes.

The file cache manager's 224 responsibilities include maintaining performance of the local computing resource. The file cache manager collaborates with the native component, which gives it performance data in order for it to do this. If both the node and the network upon which the node resides are busy, files can be transported to the file cache manager 224 and staged until there are sufficient resources to transport the file to the archive.

The file cache manager 224 also serves as a cache for files that need to be retrieved quickly or regularly. Serving retrieval requests from the file cache manager 224 avoids transporting files all the way from the remote file repository.

According to one embodiment of the invention, the business rules for how files are cached are configured on the following dimensions: what files should be cached; on what computer node was the file made or changed; how frequently does the file change; who is the owner of the file; what is the file type; what is the size of the file; what is the magnitude of the file change, which can be measured by percentage of bits in the file that changed or percentage of the file that changed or most generally how much bigger or smaller a file has become; how long will a file be cached; how many versions of a file will be cached; how long will a cache be maintained, such as since it was last retrieved or since it was last changed.

According to one embodiment of the invention, the file status manager 234 manages the lifecycle of files cached in the file cache manager 224. Files are deleted from the cache either because the rule is that they should not cache or the file cache manager 224 has received an acknowledgment from the file archive message manager 226 of a successful end-to-end transaction having occurred and there is no rule to cache the file. The file status manager 234 may instruct a cache to delete a file from its cache. The file cache manager 224 does not generate events to purge files, rather it caches files based on the instructions from up and down stream. According to one embodiment of the invention, the file archive message manager 226 sends messages via SOAP over HTTPS. In this regard, the file archive message manager 226 takes small files and packages them together for efficiency. The file archive message manager 226 also takes large files and tears them into chunks for efficiency. In addition, the file archive message manager 226 manages a hub and spoke architecture so peer computers can communicate through fire walls where it is assumed that the cloud can not initiate a socket to a local computer node.

According to one embodiment of the invention, the file archive message manager 226 manages messages transmitted throughout the system via an Enterprise Service Bus implementation as will be understood by a person of skill in the art. It includes capabilities of message transformation; point-to-point reliability, publishing and subscribing to messages, the ability to use JMS and queues, and the ability to handle WS-I (http://wsi.org) profile1 messages.

According to one embodiment of the invention, the file archive message manager 226 is configured to do mutual SSL authentication with a variety of keys from a variety of key authorities. Keys and key authorities are compliant with X.509 base specification. The file archive message manager 226 is further configured to manage Representational State Transfer (REST) messages using a get protocol as will be understood by a person of skill in the art. In one embodiment of the invention, the file archive message manager 226 is built upon the open source Enterprise Service Bus implementation. The API of the messages supported by the file archive message manager 226, however, are specific to embodiments of the present invention.

According to one embodiment of the invention, the rules engine 218 is an open source rules engine, such as, for example, drools (http://www.jboss.org/drools/), capable of executing business rules. The choice of a rules engine 218, such as drools, provides the capability to define a custom rule grammar. It also allows for a custom user interface based on the parameters of interest including populating drop down lists or other choice mechanisms. It also allows a user to compose rules from proprietary data base fields, and thus gives the customer's IT staff the ability to easily compose rules.

The rules engine 218 is configured to integrate various business objects using a declarative language of configuration. Java interfaces are supplied so that they allow the rule engine to produce the necessary code, which allows the rule engine to process syntax, as stipulated above.

The rules engine 218 takes the rule manifestations, and by evaluating their precedence, can determine which rules are of more significance, and thus, process them in an order, which would control the outcome. The output of one rule can be the input to another rule, and the business objects that are passed to the rules engine 218 become the parameters of judgment that the rules engine 218 uses in order to do this. An example of how the output of one rule can be the input to another would be the determination of whether to throttle a resource in doing a task. Thus, for example, when running a scenario and needing to know if the computer device should throttle itself while decrypting a file, the device would: request the resource manager to give it an instance of the current resources object; the device would then invoke the rules engine 218 with a rule name, such as throttle, the current resources object, and an instance of itself. The rules engine 218 using its configuration file understands how to interpret the business objects. The rules engine 218 then uses its native grammar to decide if the resources necessary for a positive decision exist for decryption or not. If sufficient resources are available, the file is decrypted, and then passed to the next queue for processing which will, if it is processing intense, repeat this process using the same rule. If the resources are not available, the queue manager pushes the object back to the front of the queue, and waits until the resources become available, and then proceeds.

One advantage provided by the system is that it allows users to use business objects that exist in the system and do things like apply regular expressions to them, combine them together, without writing the integration code necessary to do this and otherwise use the power of a rule engine. This is an improvement over prior art systems which generally require users to implement each and every policy choice by hard coding solutions to each policy choice a user has. This has two affects. First it is generally difficult for prior-art systems to get to market with new policy choices for its users, and thus, their range of policy choices is limited. Second, the rule engine is very efficient and flexible enough to be enhanced in the field to accommodate different uses of the engine.

One of the main advantages of the rules engine 218 are the objects exposed to it. Having knowledge of what application caused what file to be changed and exposing a mechanism for applying policy to this fact allows users access, in the rules engine 218, to the full power of, for example, the application information repository 126, without the inventors knowing in advance what business applications will be backed up, or what the resource availability will be on the computing systems. Also, embodiments of the present invention allows other business objects of the systems to be exposed to the rules engine 218 as they become the things which must be easily configured by users.

According to one embodiment of the present invention, any software object in the system can be used as a predicate in a rule. Examples of objects in the system that can be used as predicates in a rule include but are not limited to:

1. Objects containing information on resource utilization, such a CPU, memory or network utilization

2. Objects containing information on the names of files, paths etc.

3. Objects containing information on file status such as creation time, date, etc.

4. Objects containing information on the user's that created files

5. Objects containing information on applications that created the file

6. Objects containing information on metadata related to files

7. Objects containing information on file creation times, change times, etc.

An exemplary list of some possible sample rules include:

1. ‘Back up the ‘electronicMedicalRecordApplication’ every day at 12:30 AM. While doing so ensure that at least 60% of the CPU, memory, and network bandwidth, are available to other tasks, not related to the HIPAA Box work.

2. ‘Don't back up any files with the extension ‘tmp’, ‘$*’, ‘˜*’

3. Never allow the backup engine to consume more than 80% of system resources (CPU, Memory, Network, or Disk).

4. Back up all files from ‘Microsoft Office’ that are created or changed within 15 minutes of their change, but never more than once in 15 minutes.

5. Do the ‘HRMS data Migration scenario’ but do not use more than 30% CPU on the source node, or 70% CPU on the destinationNode.

6. Audit all changes to the ‘usr/bin’ directory. If no other rule takes precedence over this rule, do not back up any files.

7. Back up all files created by the user ‘Doctor Smith’

8. Never back up any files created by the user ‘guest’

9. If it is between 12:00 Am, and 6:30 AM, and there is at least 25% CPU available to other tasks, and no high priority tasks are in your work queues, then scan the entire file system for changes, and execute the default rule set to evaluate actions to take on files that are new or changed.

Still referring to FIG. 2 of the present invention and the rules engine 218, the following is an example embodiment of a rule, as it would appear in the application information repository 126 of rules:

Rule 1 embodiment:
Rule name: “EMR throttle”
Customer: ‘”Children's hospital”
Precedence: 100
Rule text:
“If scenario.name= ‘electronicMedicalRecordApplication’ and
CurrentResources.OtherProcesses.CPU <60 and
CurrentResources.OtherProcesses.memory>60 and
CurrentResources.OtherProcesses.network<60
then ResourceManager.throttle=true.”
Rule embodiment 2
RuleName “globalExclusion”
Customer “Children's hospital”
Precedence: 50
“if
fileStatusObject.fileName .regex= ‘$/./$?’ or
fileStatusObject.fileName .regex= ‘$/.~?’ or
fileStatusObject.fileName .regex= ‘$/.tmp’ or
fileStatusObject.fileName .regex= ‘$/.TMP’
thenfileStatusObject.task=’Ignore’

With continued reference to FIG. 2, the software components that reside in the data vault web server environment 120 on the data vault web server computers 264 include, but are not limited to, a file transporter 220; a local file transporter 222; a file cache manager 224; a file archive message manager 226; a file storage archiver 244; a virtual vault 246; a security key manager 248; a file meta data manager 250; an account repository 252; a file status manager 234; a federated configuration manager 236; an audit manager 238; a user interface 228; a file meta data viewer 230; and an audit viewer 232. The data vault web server computers 264 may be similar to the servers 122 discussed with reference to FIG. 1. The server computer 264 include one or more processors and memory. The memory includes computer program instructions which, when executed by the processor(s), provide the functionality of the software components described herein.

The data vault web server computers 264 are coupled to the file storage 124 providing persistent data storage, data structures, and database structures, the metadata storage vault 136, the audit repository 134, the application information repository 126, and the business rule repository 128.

According to one embodiment, the file transporter 220, local file transporter 222, file cache manager 224, and file archive message manager 226 residing on the data vault web servers 264 may be similar or identical to their previously described counterparts that reside on the personal computers 260 and business system computers 262.

According to one embodiment of the invention, the file storage archiver 244 is the back end of the system. It is responsible for persisting the system's state. In one embodiment of the invention, the file storage archiver is built using a storage cloud which allows remote data storage in a data center. The file storage archiver 244 is configured to manage the various computer nodes 260, 262 of the system, store the state of the system, and run a graphical user interface (GUI) for users accessing the system via the Internet and not via local instance of the GUI. The file storage archiver 244 is responsible to receive data from all nodes that need to update its repository. The file storage archiver 244, is also responsible to distribute data to all nodes that need it to achieve recovery and migration of data previously saved.

According to one embodiment of the invention, virtual vault 246 is configured to store data for the system. It is constructed to take advantage of the compression, availability, tagging, and business capabilities of the system opaquely. It is optimized for privacy and security. For each file, two types of data are stored: the metadata about the file, and the file itself. Both are protected and stored in a variety of ways. According to one embodiment, each file is stored outside of the database. Alternatively the files are stored inside the database.

According to one embodiment of the invention, the security key manager 248 manages the public PKI keys of the system. In this regard, security key manager 248 monitors key expiration and notifies the key vendor that a new key is needed and where to send the key. Keys are sent to the user, and installed via automation. The system checks that the new key has been installed. In one embodiment of the invention, one week before a key is to expire, the system checks if a new key has been installed and, if no new key is available, an operational call out is made to the staff of the system. The system operator rectifies the situation and informs the system, through the user interface, that a new key is available. The system repeats the check for keys expiring within one week every 24 hours. If a new key has not been made available by the 4th day, the system notifies a more senior officer of the system operations.

According to one embodiment of the invention, the file metadata manager 250 provides a federated service oriented data vault that is data driven rather than a hard coded file or document manager. According to one embodiment, an advantage of the file metadata manager 250 is its ability to present its data using structured views the user wishes to see, and a standard SQL interface which any information manager using the ordinary art can understand. This allows the system to present a secured SQL connection which only give a user the data they are allowed to see, and abstracts data base load away from the data base tier and distributing it to the application server tier. This allows database administrators and business intelligence tools to use the system out of the box with little work, this puts the control of reporting on the end users.

According to one embodiment of the invention, the system provides metadata that stores information about active files. Metadata has a structural and non-structural component. Structural metadata is represented by the facts stored and associated with each file as it passes through the business rules and is uploaded to the metadata storage vault 136. Tags provide non-structural metadata. As described above, the tags belonging to a stakeholder appear as structured data to them and the reporting tools they deploy against this system. Structured data is also stored in the metadata storage vault 136, within a traditional relational database management system, with a schema that enforces the integrity of the business rules that are associated with this data, and is constrained by the information existing in the application information repository 126, which is concerned with the metadata about the applications which produce the information about the active files referred to above.

According to one embodiment of the invention, the file metadata manager 250 receives the header information for all messages and adds metadata about the file to the metadata storage vault 136. The file metadata manager 250 is configured to make inferences about the files that are stored and create and store metadata relevant to those inferences. For example, a file created by a doctor and stored locally in a directory called “Findings,” can be automatically tagged with the term “diagnostics.” The system contains default business rules that perform this kind of inference, and users can add their own customized business rules into the business rules repository 128. Using these tags, restoration rules can then use the customer supplied information in order to create a set of rules, using a set of variables not conventional in the prior art. This adds to the flexibility of the system, and allows the users of the invention to get to market with rules not supported explicitly by the invention. This ability to infer the nature of files uploaded to the data storage vault 124 from metadata stored in the metadata storage vault 136, is an example of a benefit provided by the file metadata manager 250. Business rules are customized in the federated configuration manager 236.

The file metadata manager 250 is further configured to classify files in accordance to the metadata tagging protocol described above, and from other rules. This method allows for many dimensions of automatic metadata determinates. The metadata about files includes, but is not limited to: (1) user who created the file; (2) user who modified the file; (3) data of file creation; (4) data of file's last modification; (5) frequency of modifications; (6) directory of modifications; (7) tags associated with files or networks of files; (8) tags associated with the directory or other location characteristics of files; and (9) computer where file is stored.

According to one embodiment, the file metadata manager 250 is also configured to make metadata secure on two dimensions. Metadata stored by the file metadata manager 250 is secured even though the system has a cotenant model as will be understood by a person of skill in the art. This is done with appropriate entitlement management, as well as by the proprietary SQL driver described above. The file metadata manager 250 uses the business rules repository 128 and the application information repository 126 in order to manage a business's end-to-end data continuity policy. A business categorizes its applications, selected from the application information repository 126, into tiers of service associated with the business criteria for the tiers of service they configure through the user interface 228. The user from the business then assigns service level agreement (SLA) parameters, such as how long data may go without being backed up, recovery point objective (RPO), and amount of time it is acceptable to be without this data and function, which is referred to as the recovery time objective (RTO). The file metadata manager 250, then composes the appropriate policies to display to the user, which, in human understandable, business language, describes this policy, and composes the machine readable rules as described below. These rules are then deployed to the personal computers, or servers using the messaging infrastructure described above. The files are then backed up as described above in accordance with the business rules. They are then managed in accordance with the policies that are created by this process.

Because applications listed in the application information repository 128 can be specific to particular industries, such as, for example, the US Health Care Provider industry, and because the policies are configured to be controlled by the legal regulatory climate of these industries, the system is configured to assign each business with default industry-specific application portfolios and default industry-specific policies around the data continuity. Each business can then customize these default industry-specific policies and application portfolios via the user interface 228. This allows a traceability from a business environment to the low level tasks of managing the back up and testing recovery. This creates a tool set that not only is capable of backing up files, but recovering them, and testing the performance of these tasks against generated policies as a way to audit, in a business sense, the user's compliance to their policies, which would be pre-configured to meet the regulatory requirements within the vertical industry assigned to a user. For example, if in health care industry there are 5 major electronic medical record vendors, the system allows a health care user to browse the application information repository 128, and pick the one they use, and then assign the proper set of policies to service level agreement management. Further, the system allows the user to drill into a dashboard in order to understand anomalies from their compliance to those policies.

According to one embodiment of the invention, the account repository 252 manages the administrative aspects of the customer's financial, business, and technical relationship to the data vault. This component is, according to one embodiment of the invention, part of the repository which is exposed to the reporting functions and administrative functions that are provided to the customer. The administrative functions provided to the customer include, but are not limited to: (1) computer node creation; (2) user management; role management; (3) billing; (4) reporting; (5) security incident and resource availability; (6) operational management; and (7) business rule management.

The account repository 252 is the customer relationship management (CRM) component of the system. It records all active accounts and associates search account with the relevant financial facts. According to one embodiment, the account repository 252 can be used to report on billing and other activity for an account and its users. This reporting is controlled by the repository operators and by the account holders or their delegates. The reporting function is discussed below with reference to the audit manager component

The account repository 252 also supports the tagging of accounts and account users. Tags are non-hierarchical keywords assigned to a piece of information to facilitate the search and retrieval of data. The system provides a number of pre-defined tags and users can create any number of their own tags. The system also supports private tags for use by system operators. These tags are not visible to users. An example of system tags include tags generated by a solution vendor, such as, for example, an electronic medical record vendor. Such a vendor might have files arrayed in a configuration directory on an application server, on user's computers configuring their local applications, in an entitlement system, and within a database's repository. Such a vendor could assign a system vendor tag to all of these files with the tag ‘EMR Vendor [vendor name] files.’ Then, as needed for forensic or disaster recovery, this network of files could be restored to a set of computers as necessary.

According to one embodiment, every significant piece of information in all repositories may be tagged. Reporting based on these tags is an example of how the system allows for unanticipated flexibility.

Unlike traditional CRM and financial systems, the account repository's 252 reports are not bound to static, structurally defined mechanisms of extracting data. If the user wishes to apply a set of tags based a set of clear facts that can be detected by the business rule engine, then reports can be dimensioned based on rules that a user creates.

According to one embodiment of the invention, the account repository 252 allows a user to create any number of proprietary tags, to associate tags with records, and to report on tagged information with native query performance from the database, and by using the data base interface as described above. The system achieves this native query performance by automatically creating materialized and indexed views optimized for tagged information

According to one embodiment of the invention, the file status manager 234 realizes the administrative capabilities of the system. The file status manager 234 has many sub components. These sub-components have no particular capabilities beyond the capabilities of commercial off the shelf components. Below we briefly describe the capabilities of each subcomponent.

According to one embodiment of the invention, the federated configuration manager 236 works closely with the security key manager 248 to enable an organization to operate in a federated manner. According to one embodiment, federation is a hierarchical collection of organizations in which authority is delegated from the central authority to their child organizations. Each child organization, in turn, can retain or delegate authority to its own child organization. Each organization may have individual people as members and a person may belong to more than one organization. Each person belongs to one primary organization. Peers in the federation might know nothing of the rules of the other members of the federation. A name space scheme is used to allow each federation to name identical resources and rules, but to ensure that they are encapsulated from one another.

According to one embodiment of the invention, the audit manager 238 is capable of reconstructing any business record based on a change. The audit manager 238 is not able to understand the content of any archived files. Its function is to allow a user to forensically understand patterns of change management across the file system, as well as to understand patterns of compliance with the service level agreements for each business application. According to one embodiment, with the exception of error details in the error log, all events can be audited. The basic capabilities of the audit report are realized using a standard business intelligence platform. In one embodiment of the invention, this is accomplished by supplying read only database drivers as described above. In addition, the graphical user interface which is further described below, supplies sets of standard audit reports which are available on a daily, weekly, monthly, and annual basis, as well as over the life of any account. The audit reporter is capable of doing arbitrary ad hock reporting based on the tags associated with any record.

According to one embodiment of the invention, the file metadata viewer 230 allows a user to see all of the facts about the files under management by the system. It also allows the user to request an inventory of files on a computer not under management. The file metadata viewer 230 allows the user to query against file metadata based on the metadata facts about the files. Queries against the files include but are not limited to queries of ownership, application that produced file, size, back up frequency, back up versions, data of query, computer that owns a file, group of computers that own a file, security group that has encrypted the file (if encrypted), rules that govern the file's management, and distribution of files based on the file's versions across computers. From an entitlements perspective, users see metadata about the files on the computers that they have responsibility for.

According to one embodiment of the invention, the audit viewer 232, allows a user to view the user created business transactions that have taken place and activities taken by users, which are all auditable. Those business events can be viewed using the audit viewer 232. In this regard, a user submits a query based on the type of business event, owner of business event, and time frame of business event. From an entitlements perspective, a data filter will be applied on two dimensions. According to one embodiment, users are entitled to audit the types of records which they have the right to audit, and see the data about audit events when the data affects the computers that they are entitled to manage.

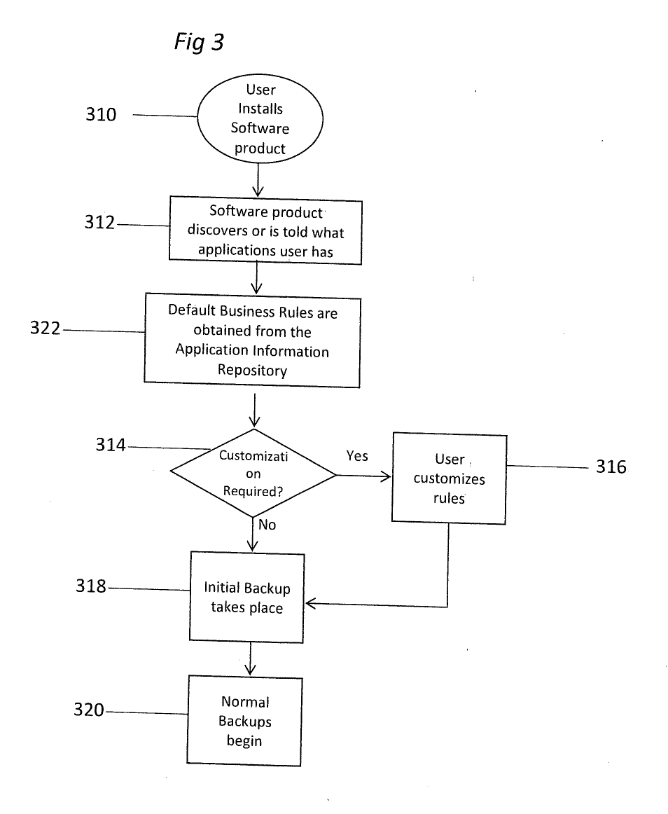

FIG. 3 is a flow diagram of steps taken during an installation and configuration phase according to one embodiment of the present invention. In step 310, a user installs a software product on the computer system(s) 260, 262 to be monitored. The software product comprises one or more of the software components as described with respect to FIG. 2. In step 312, either the software product automatically self-discovers what applications are running on the target computer system(s) 260, 262, or the user inputs to the software product what applications are running on the target computer system(s). In the automatic self-discovery mode, the file event processor 121 is invoked to observe all file events generated by different applications installed in the computer system(s) 260, 262. Using the information discovered during file event observation, the software product maps the process ID to the application name that caused the file event, by comparing this information to the information in the application repository. Discovering the application name that causes a file event allows identification of relevant backup rules where such are organized in the business rules repository 128 based on the name of the application to which they relate.

Once all applications have been either automatically discovered or input to the system, in step 322, the default backup business rules for all discovered applications are obtained from the application information repository 126. In step 314, the user is given the option of accepting the default backup business rules or customizing the rules. If the user decides to customize the rules, the software product provides, in step 316, a graphical user interface for allowing the user to customize the business rules. Once the business rules are either accepted as-is or customized, the process proceeds to step 318, which does an initial backup of all relevant files based on the business rules. Once the initial backup of all relevant files is completed in step 318, then the normal incremental backup process begins in step 320. During step 320 the system performs incremental backup of all relevant files as specified in the previously accepted business rules.

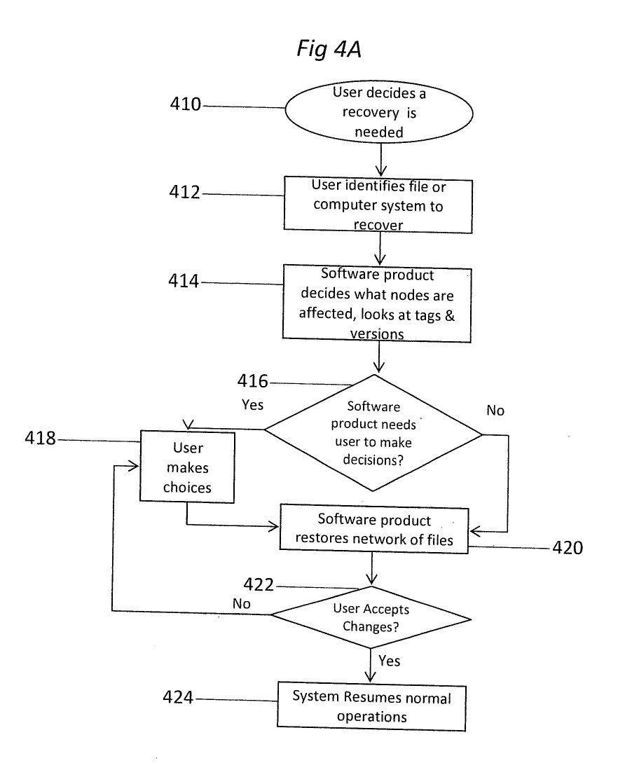

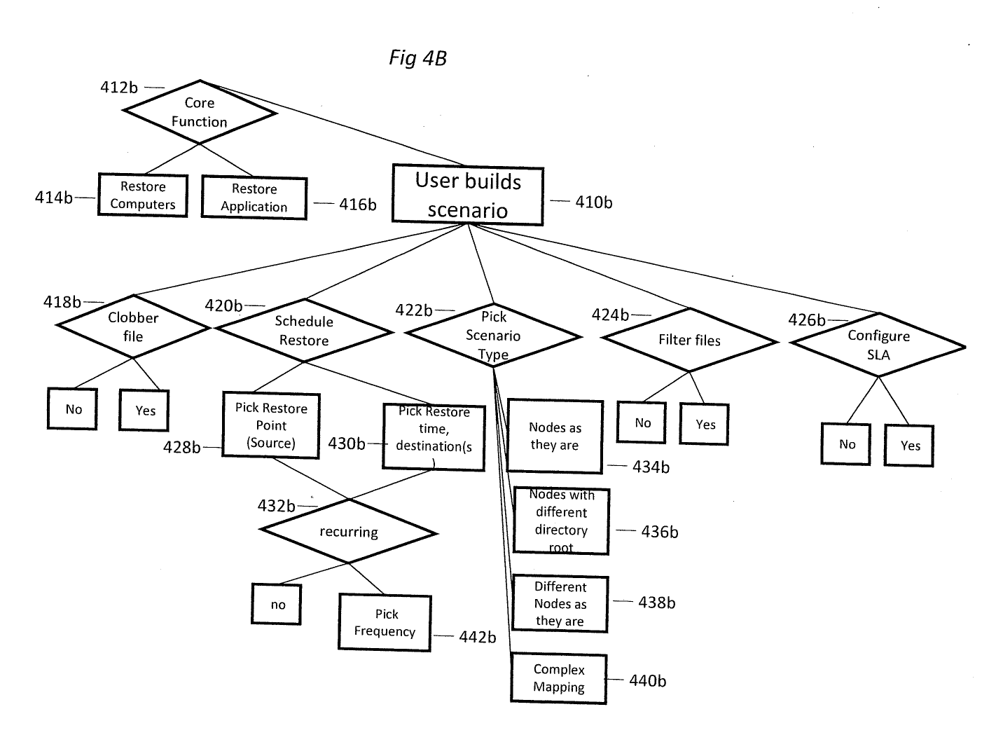

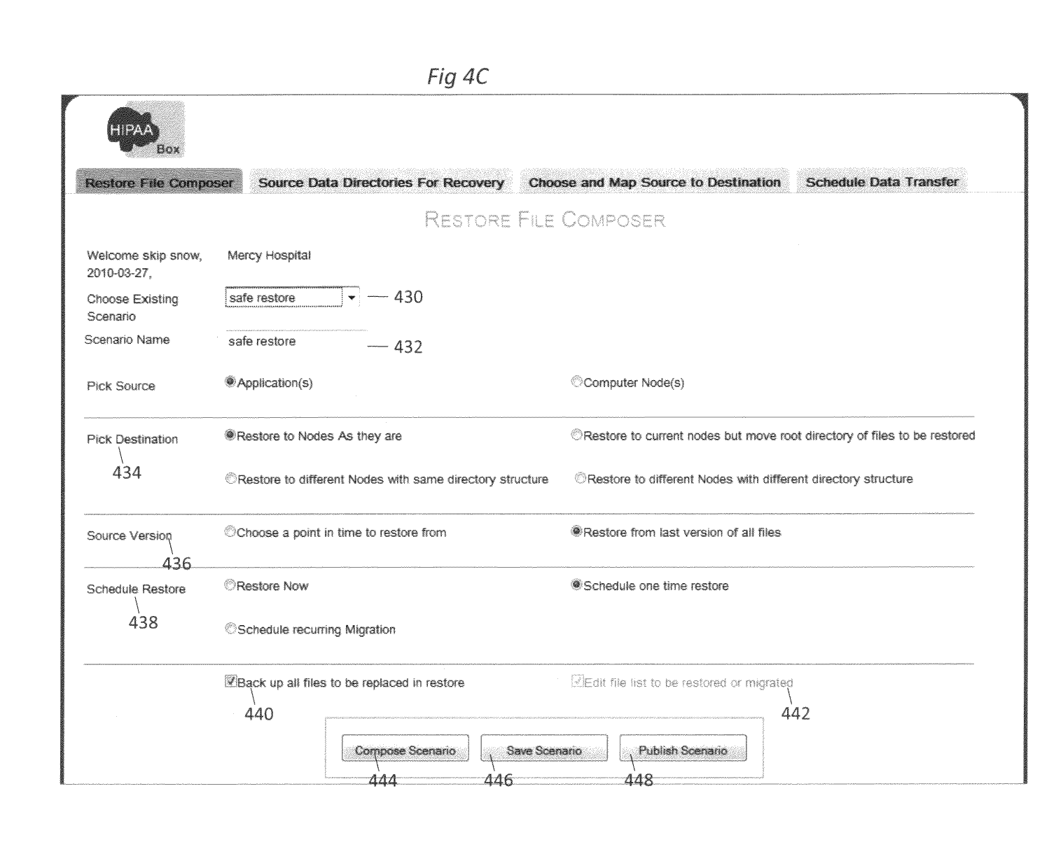

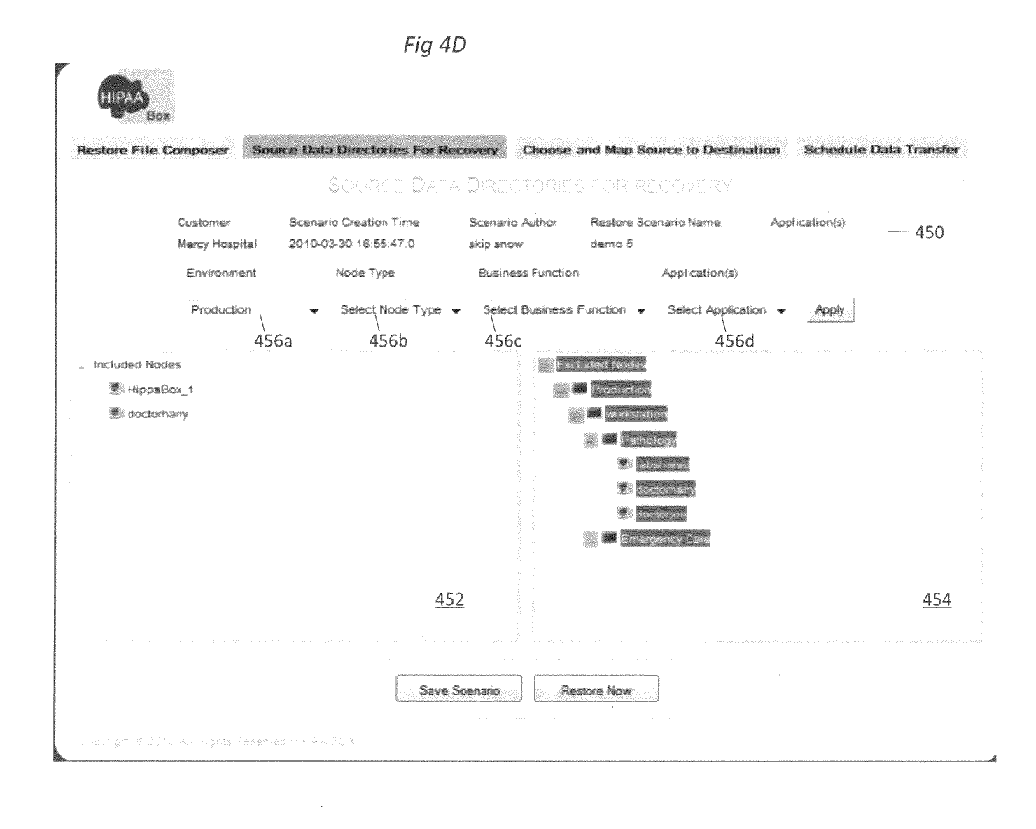

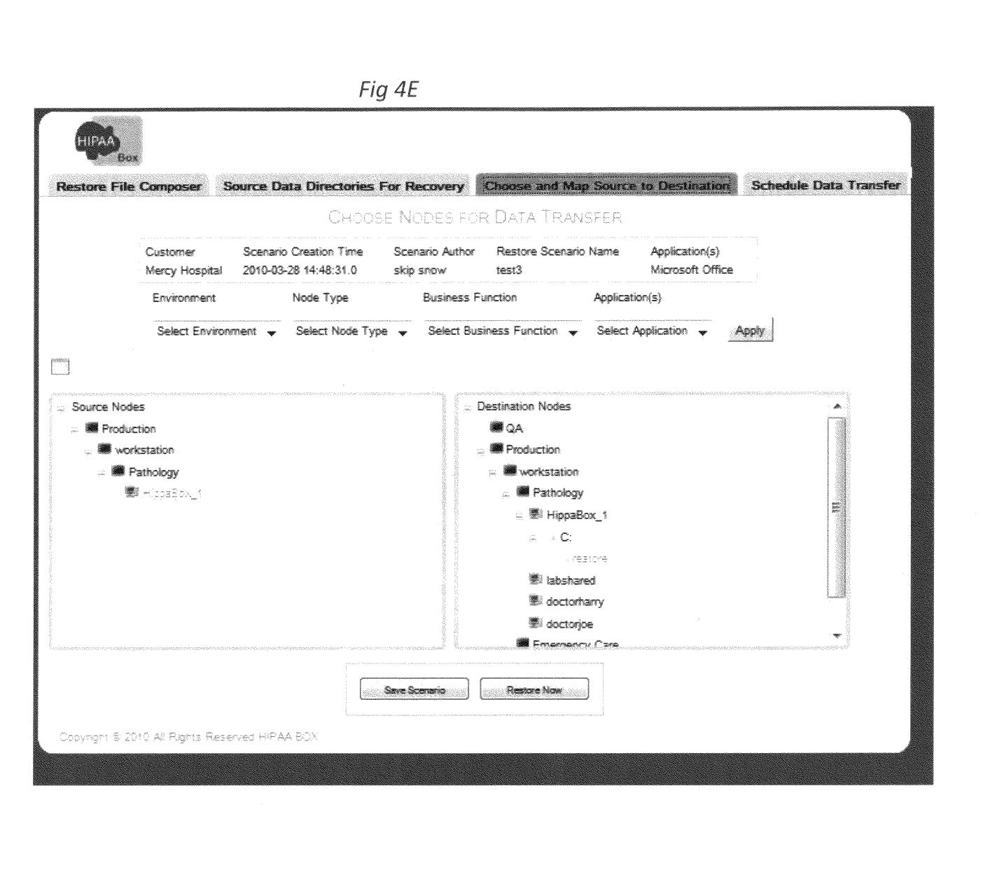

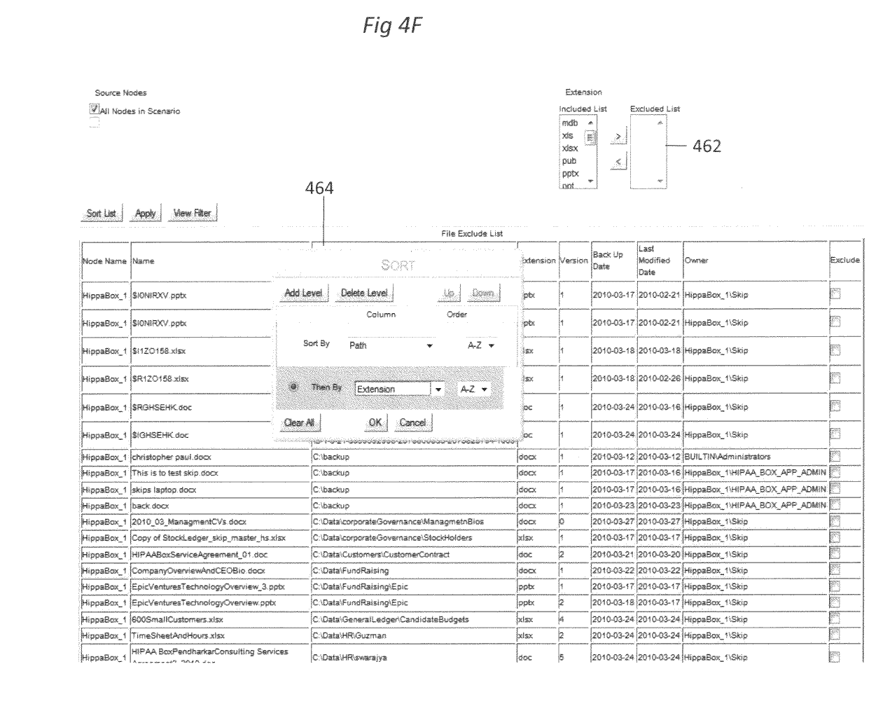

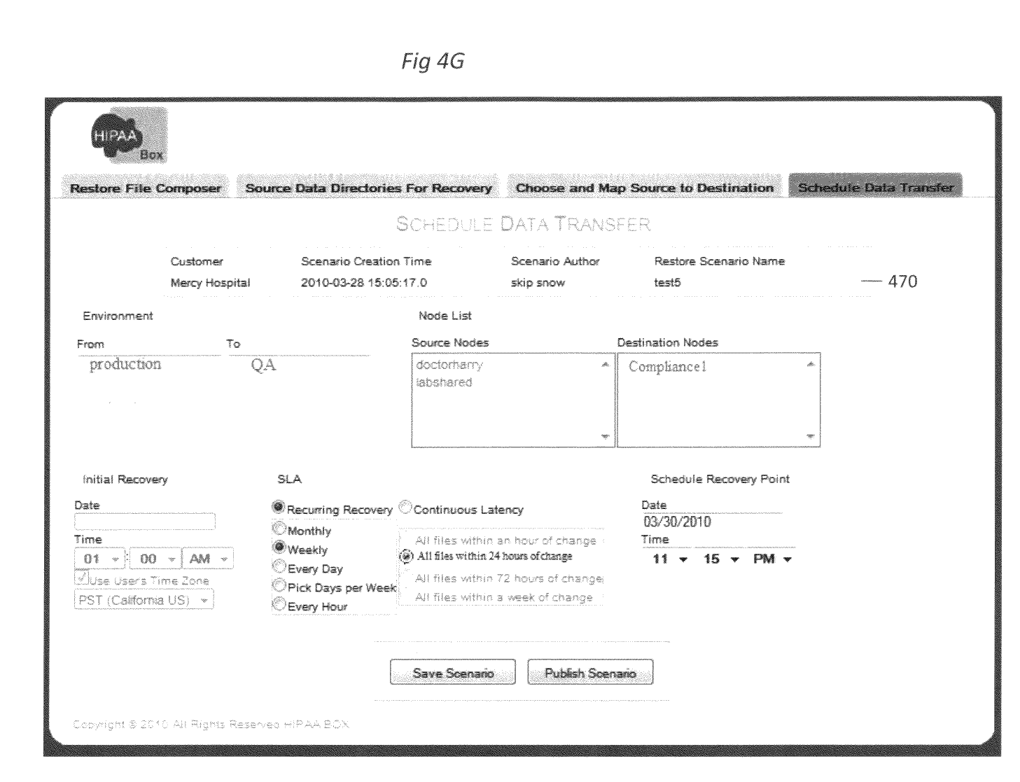

FIG. 4A is a flow diagram steps taken during a file recovery phase according to one embodiment the present invention. In step 410, as depicted in FIG. 4A, the user decides that the recovery of a file or set of files is needed.

In step 412, the user inputs into the system, using the user interface 228, the file or set of files to be recovered. In step 414, the software product decides what computer node(s), both personal computers 112 and business system computers 114, in the user's business enterprise environment 110 are affected by the recovery of the specified files. In step 414, the software product also checks for the versions and associated metadata tags of the files to be recovered based on metadata information stored for the files in the metadata storage vault 136.

In step 416, if the software product needs the user to make any decisions about the file recovery, the user is prompted to enter data using the user interface 228. If any user decision input is needed, the user enters those choices in step 418. Once user choices are made or if none are required, the system proceeds to step 420 where files are restored to the appropriate computer nodes previously identified in step 414. After file restoration, the software product prompts the user in step 422, to either accept the file recovery as-is or request additional changes. In one embodiment of the invention, some of the options a user may make as they configure restoration or migration scenarios via the GUI include:

What specific files should be eliminated from the scenario

What specific types of files should be eliminated

Where should the directories on computer nodes, being restored or migrated to be mapped to on the restoration computers

When should the restoration take place

How long should the restoration take

How often should the migration take place, if for example there is a daily migration job from one computer to another?

If the user requires additional changes the software product, the process returns to step 418 for receiving additional file recovery requests or modifications from the user. Once the file recovery is accepted as-is, the software product proceeds to step 424, where normal operations of the system resume.

FIG. 4B is a conceptual diagram of how a user creates file restoration scenarios or computer system restoration scenarios in one embodiment of the present invention. According to one embodiment, the user builds scenarios 410b using a GUI interface. In another embodiment of the invention, the user builds scenarios by being guided through the process using a wizard. In either embodiment, the main functions 412b of the scenario building process include creation of scenarios to either restore computers 414b or to restore applications 416b. There are 4 exemplary scenario types that a user gets to choose from, from very simple to very complex.

1. Restore to the node where the files came from as the nodes were. In this case no mapping can take place, but SLA information can be configured as well as the timing of the restoration and the like.

2. Restore to the same node, but restore to a particular directory structure. This allows the user to move all of the files to a logical root. This further allows the user to rehearse a restoration without destroying the current state of a system.

3. Restore to a different node but without altering the directory structure. This is the basic migration scenario.

4. Restore to the same or a different node with complex mappings. This allows the user to arrange for a restoration where for example, a production system exists on 3 computers but in the continuity of business environment all the nodes have been collapsed to one node, and thus, the mappings of the directory structures are not the same.

According to one embodiment of the invention, among the items the user is allowed to make choices about concerning backup and recovery scenarios includes, but is not limited to:

1. In the configure SLA step 426b the user can choose the service level agreement associated with a restore (i.e., choose how long the system has to do the job)

2. In the clobber file step 418b, the user can choose whether or not files that are being restored, and that are being clobbered (meaning a file already exists at that path and with that name), should be backed up.

3. In the filter files step 424b, the user can choose whether all files that were backed up should be restored.

4. If the restore is to a new environment (i.e. a migration to a different set of computers), then the user chooses the environment to which files should be restored.

5. In the case that a user wants to restore a set of data to a different location, the user gets to choose to do that.

6. In the schedule restore step 420b, the user can choose when the restore should take place.

7. In the pick restore time/destination step 430b, the user can choose from what moment of time should the restoration take place.

8. In the recurring step 432b, the user can choose in the case of migrations to have restorations take place on a regular basis. For example, if a user wishes to maintain a continuity of business environment, they might wish the data to be migrated every day, or every six hours, and they can configure this.

FIG. 4C is a screen shot of a GUI allowing the user to make choices which controls the complexity of the restore scenario that they are about to compose, according to one embodiment of the present invention. For example, the user names a scenario, or locates a scenario they want to work with via controls 430, 432. They choose to work on business applications, which will imply certain topologies, or particular computers. They choose one of 4 core scenario types 434, which in increasing complexity are:

Restore nodes as they are

Restore to current node, but move root directory of files to be restored

Restore to different nodes with same directory structure

Restore to different nodes with different directory structures.

Depending on the user's choice here they are offered increasingly complex sets of choices as they move through the UI wizard, which is the restore wizard. In the next set of controls, labeled source version 436, the user configures if the system should simply choose the most recent file and restore it, or restore as of some failure point. For example, if one of the computers 260, 262 became corrupted last Wednesday, the user can pick a moment of time from when the files will be restored. Thus, no file that was backed up after that moment of time would be restored.

A next set of controls, labeled schedule restore 438, allows the user to choose when the restoration is about to take place, and if the restoration is recurring. If it is recurring, then the user in most cases will be doing a data migration from a source system to a continuity of business system, or regularly migrating files in order to move data to staging areas for ETL jobs.

Option 440 allows the user to choose if the files which are over written on a computer should be backed up when a restore file replaces it or not. Option 442 allows the user to eliminate certain files by hand from this restoration scenario.

Still referring to FIG. 4C of the present invention, when the user is finished composing the scenario, or when the user wishes to take a break they may either choose to compose the scenario 444, or save the work 446. In either case the work will be saved. If the user has navigated back to this screen then they may publish the work 448, which means that the work will be deployed to the node and the scenario will be run, at the proper time.

FIG. 4D is a screen shot of a GUI allowing a user to pick the source computers for the scenario according to one embodiment of the present invention. The user gets a set of meta-information about the scenario in a header section 450, and drags and drops nodes from an excluded list 452 to an included list 454, or from the included list to the excluded list. One or more filters 456a-456d may be set to organize the view of the nodes for the user, to eliminate different classes of computers. In the example of FIG. 4D, the user has filtered out QA and COB machines, and is only looking at the production environment. The software product can filter on various criteria, and can allow the user to configure which filters are of significance to them.

FIG. 4E is a screen shot of a GUI that allows users to map which directories are of interest to them, and which directories will receive restored or migrated data, according to one embodiment of the present invention. In the screen shot of FIG. 4E, the same filtering capabilities, and same metadata is displayed to the user as in FIG. 4D. However, on this screen, which allows users to map which directories are of interest to them, and which directories will receive restored or migrated data, several conveniences are given to the user. A simple drag and drop functionality is given to the user to allow the user to easily map complex structures. The maps may also be color coded so the user can easily identify what they have mapped if they are doing complex mapping. In the illustrated example, the user is doing a map where two nodes are being migrated to particular directories on other nodes. The user can map at a directory-to-directory level.

FIG. 4F is a screen shot of a GUI for allowing a user to eliminate files according to one embodiment of the invention. The files may be eliminated one by one by checking an exclude box. The user may also move file extensions into an exclude list 462 for eliminating classes of files A pop up window 464 allows the user to pick the sorting order of files to be eliminated. A search box may also allow the user to find files using a typical search pattern matching algorithm in order to quickly find the files that he or she is trying to eliminate.

FIG. 4G is a screen shot of a GUI for allowing a user to both set a service level agreement for how long a restoration would take place, and plan for when the restoration is to take place, and from what time the last back up will be, according to one embodiment of the present invention. For the user's convenience some details about the computers that are in the scenario are displayed in section 470, which makes it simpler for the user to make choices about the parameters of service level, and timings. In this screen if the user wishes to continuously migrate data as soon as it is backed up from one place to another, they may configure not only that the system does this, but how often the system does this. Allowing the user to do this allows them to provision a continuity of business environment cost effectively, and without the ordinary engineering hazards of doing this.

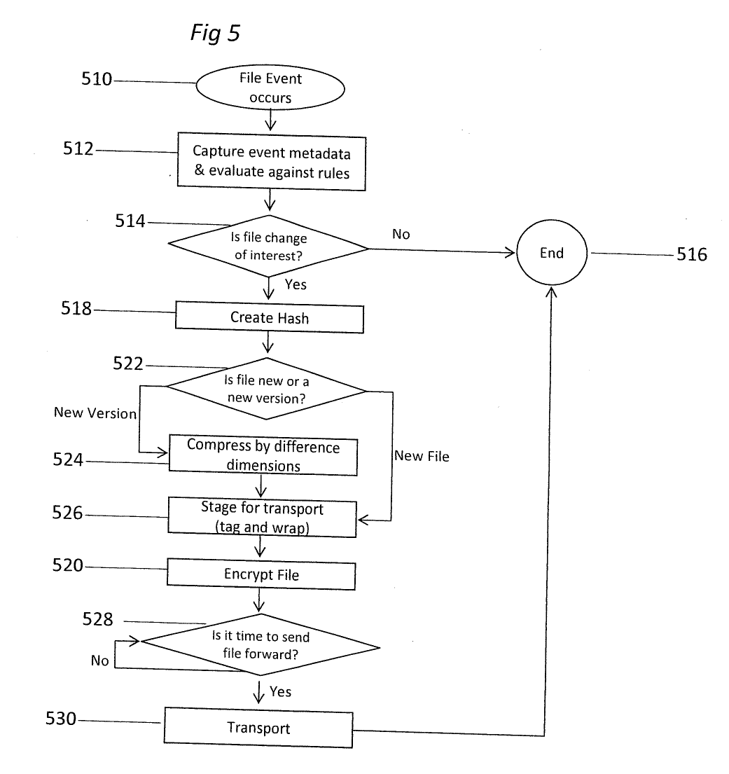

FIG. 5 is a flow diagram of steps taken during a file archive phase according to one embodiment of the present invention. In step 510, a file event occurs and is observed by the file event processor 212. In step 512, the file event processor 212 captures event metadata and evaluates it against the pre-established business rules. The rule engine can compare the current file event to the last file event of the same file. For example, the duration between file backups can be evaluated. In addition, metadata criteria may be evaluated. Examples of metadata criteria that can be evaluated include but are not limited to: filename; file path; application that produced the file; process that created file; file size; file type (MIME extension); security attributes, as an opaque string, i.e. was it changed; file saved data, and the like. In addition to such example metadata criteria, other file metadata may also be evaluated. For example, if this is not the first of a file, the file can be tagged with an arbitrary tag that is generated by the user and that tag can be evaluated in a rule. For example, the system might have tagged the file as a data, program, or configuration file. This tag, or even multiple other tags, may be used to make an evaluation. Furthermore, dates, strings and integers may be operated on in rules for duration with regular expressions or via mathematic algorithms.

In step 514, the file event processor 212, decides, given the business rules (either the default global rules or custom rules) whether this file change is of interest. According to one embodiment of the invention, the file change is of interest if either there is default global backup rule or the user has created a custom backup rule which results in this file change being considered of interest for backup purposes. The power of the rule engine is to allow the user to determine this without being constrained by a static set of coarse-grained variables that can be compared in coarse-grained ways. Instead, embodiments of the present invention allow the user open-ended flexibility in determining the rules. For example, a user can create a rule of priority where one file is more urgently backed up than another. This may be achieved by setting the available resources to do this job as higher then the other. For example, a user might command the system to back up the entire computer at a low priority, but the changing data file at a high priority. If the file change is not of interest, the file event processor 212 ignores it and proceeds to step 516, which ends any processing of this file event.

In step 514, if the file event processor 212 decides the file change is of interest, the system proceeds to step 518. In step 518 the local file manager 210 creates a hash of the file change. The hash for the file change is created as follows according to one embodiment of the invention. First, the local file manager 201 combines two standard hashes SHA and MD 5 with the size of the file. While there is a chance mathematically of a collision, it is statistically considered to be impossible. Any of the three variables can allow for collisions, but the chances of all three colliding are overwhelmingly low. Partly this is because neither hash uses the size of the file as a variable, and the chance of their ability to collide goes up with size of file, while the chance of receiving the same two hashes with the exact same size file goes down. Thus, the hash algorithm utilized according to one embodiment of the invention opposes itself in its propensity to create a collision. Once the hash of the file change is created in step 518, the system proceeds to step 522 where a check is made to determine if the file change is for a new file or a new version of an existing file. This check is done, for example by first checking the local store for a copy of the checksum and then checking the remote server for a copy of the checksum (hash). Furthermore for each block a check is made, which makes the de-duplication mimic the most robust physical de-duplication algorithm, while taking advantage of the selectivity of a logical de-duplication.

After the hash of the file change is created in step 518, the process proceeds to step 522, where the local file manager 216 collaborates with the file status manager 234 via the messaging infrastructure to determine whether the file change is for a new file or a new version of an existing file change. If the file change is a new version, the process proceeds to step 524, where the local file manager 216 compresses the change by using an industry standard block algorithm. In this regard, the user sets a file block size globally per security zone, and then each block, no matter what file they come from, is regarded as unique,. In this manner, a higher level of compression is achieved because a block from one file that is identical to a block from another file will be regarded as one piece of data and only be backed up once, even if it exists in several files that ostensibly have no relationship to one another. Specifically, the backup mechanism according to embodiments of the present invention causes the system to not only incrementally backup files, and not only look at the incremental differences in files themselves, but makes the system aware of identical blocks of data across the enterprise, causing each block to be backed up uniquely only one time.

In this regard, for each block the computer(s) 260, 262 examine all the extant blocks. If the file storage vault 124 already stores these extant blocks, it does not replicate them more then once. This is done via a many-to-many join in a ‘join’ table between physical files and blocks. Thus any block could be de-duplicated across any file. As a flow, all the block checksums are sent to the server, if and only if the computer(s) do not know, from their local store, that they exist. If an identical block already exists on the server 264, it is not sent to the server. Thus, only one unique copy of the block exists at the server.

According to one embodiment, this is made a bit more complex due to tracking of the unencrypted check sum and the encrypted check sum. Thus, according to one embodiment, de-duplication is performed on a per customer, per security zone basis.

Once either the file change has been compressed in step 524, or it is determined in step 522 that the file change is for a new file, the process goes to step 526. In step 526, the local file transporter 222 stages the file change for transport by tagging and wrapping it with the metadata that the file manager 216 persisted on a queue. Once the file change has been staged for transport in step 526, the process proceeds to step 520 where the local security manager 216 encrypts the file change.

Once the file change has been encrypted in step 520, the process proceeds to step 528 where the local file transporter 222 determines whether it is time to send the file forward or not. The determination is based on resource availability and is driven by a rule. If it is not time to send the file forward, the local file transporter 222 waits to forward it later. If it is time to forward the file, the file transporter 220, in step 530, transports the file change and then ends the processing of this file change in step 516.

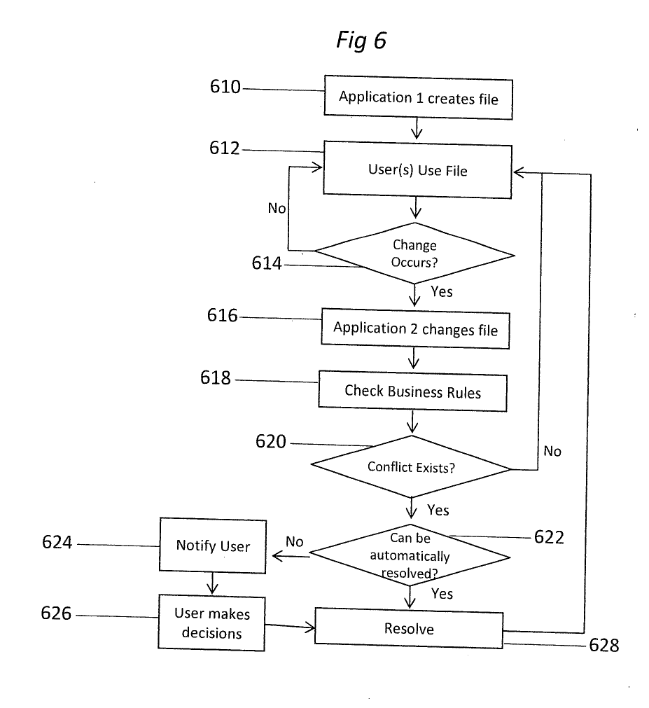

FIG. 6 is a flow diagram of steps taken during proactive observation of file events to enforce compliance with a user defined business rule according to one embodiment of the present invention. FIG. 6 illustrates an application of the usefulness in observing file changes. It shows how a file change on can be assured to have come from one, and only one application, or other variable(s) that can be determined by a business rule.

An application creates a file in step 610 and then uses a file such that a change occurs in step 612. The file event processor 212 notices this event and sends information to the local file manager 210, which invokes the rules engine 218 as described above. A rule is present which stipulates that if such an event occurs, the metadata associated with this change shall be observed, or backed up. Examples of metadata changes that can be backed up include characteristics of the files such as security changes, file name changes, file ownership changes, and time of last change. Other examples of metadata changes that can be backed up include changes that occur when a file is moved from one place or is copied from one place to another, even if no change take place in the file. The above examples are illustrative of metadata changes that can be backed up but are not exhaustive. The rule can further stipulates that if any application other than application 1 modifies a file meeting, the criteria that makes this file unique causes an alarm to be registered in step 614. Later application 2 changes the file in step 616. The rules engine 218 is invoked again in step 628.

With reference to step 620, if a determination is made that a conflict exists within the rules engine 218, a check is made to ensure that this conflict cannot be resolved automatically. In this regard, all rules are assigned a precedence value. Thus, conflicts may almost always be resolved automatically by applying the rules in a forward chaining order such that the successive iterations of the rule engine will win in conflicts. Each rule is assigned a precedence integer, and that integer determines the order of execution. The lowest integer assigned to a rule wins in a conflict. It is the user's job, to order the rules. The GUI tools makes assumptions about precedence values, but the users ultimately can configure their own precedence if they choose. According to one embodiment of the invention, if application 2 is the local file manager 210 or any component of FIG. 2, and this occurs during a data restore or migration, this conflict is resolved automatically in step 622. Otherwise, if the conflict cannot be resolved, then the user is notified using the audit manager 238 which is capable of sending notices to the user.

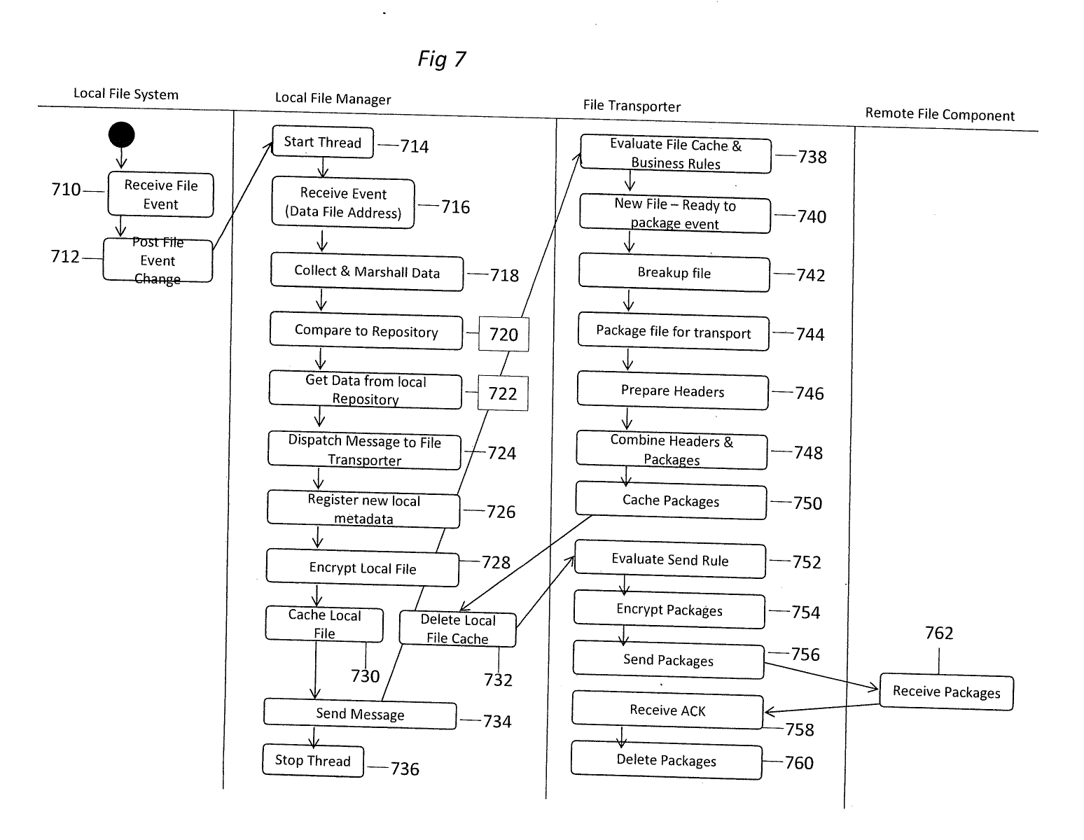

FIG. 7 is a flow diagram of steps taken to migrate a file from one of the computer devices 260, 262 to the remote data vault web server 264 when a file change event occurs on the local operating system of the computer device. According to the embodiment of FIG. 7, the local file manager 210 communicates directly with the file archive message manager 226 and a file is moved from the local file transporter 222 to the archive via the file archive message manager 226.

In step 710, a file change event is heard by a small native computer program, which is listening to the local operating system for file change events. The event invokes the local file manager 210 a Hyper Text Transfer Protocol (HTTP). In one embodiment of the present invention, the implementation of the HTTP listener uses Apache's Tomcat for quickly dispatching a new thread and returning a response to the native client as soon as the task is put on the queue, using a newly spawned thread.

According to one embodiment of the invention, the native component in step 710 is not responsible for storing state, except to persist log messages when errors occur.

When Apache's Tomcat receives the message from the native executable, it passes it to the local file transport 222, which stores the unprocessed message as a raw transaction in a queue in the database. The file transporter 220 then dispatches a thread from a thread pool in step 714, and returns a positive acknowledgment to the native executable. In step 716 the local file manager 210 receives the file event data. According to one embodiment of the invention, this entire process is configured to take less than 100 milliseconds. The real work takes place without an open socket to the native executable, which is seen as the simplest component specified by the process.

If the business rules related to this file change qualify as an observation, the Java API is used by the local file manager 210 to collect metadata about the file in step 718. The metadata is stored in the database in step 726. The file archive message manager 226 does not dumbly archive any changed file. The business rules, discovered by calling a rule in the rules engine 218 determines whether a change requires archiving. The business rules can use the entire span of the metadata to make this determination, including the tags associated with a file. When these two parts are processed, the original record in the local relational database system entered in the unprocessed queue is deleted. The deletion is performed to ensure the database is as compact as possible. This allows the memory and storage requirements on the local component to be kept thin.

In step 728, the file is collected into the memory of the JVM by the local file manager 210, and then packed in a file XML snippet. Additionally in step 728, if the file is too large to be processed by the JVM, it is encrypted, and then encapsulated in several serial snippets. The maximum size of a file is configured on each client and is based on available resources.

Once the file, is encrypted, in step 728, it is stored in a cache in step 730 by the local file manager 210. According to one embodiment of the invention, both the file and its XML wrapper are encrypted. If a multi-part file is to be encrypted, the library understands the sequence of parts, the number of each part, and the total number of parts prior to wrapping a part in the XML wrapper. Details of multi-part files are embedded in the wrapper.

In step 734, a message is sent to the file transporter 220, and the thread that was started above is returned to the thread pool in step 736.

In step 738 when the message is received, the file transporter 220 first collects the metadata about the file and determines from its cache and business rules how to package the file. Files may be combined with other files to optimize communication when they are small. According to one embodiment of the invention, a determination is made as to whether the file small enough to be packaged without being broken up. A business rule determines the maximum size that can be transported in one message. According to one embodiment, the maximum size is 10 megabytes, but this size can be reduced or increased by a business rule. Another determination that is made is whether the file can be packaged with other files. If it is small enough, and if other files are available in the cache to be transported at the same time, then the file is packaged. Again the maximum size of the package is considered. According to one embodiment of the invention, the data that is packaged for being transmitted are the changed file blocks (i.e., the changed payload contents of the file) and their associated metadata.

In step 740 the file transporter 220 creates a files package. A files package is a bundle of files. The maximum size of the bundle is determined by configuration settings. There is no practical minimum size. For example, a very small file could be transported based on business rules. According to one embodiment, files are packaged using SOAP and WS attachments.

In step 740, when a new file is received, the file size and delivery urgency is evaluated. If it can be delivered to the next node over time, then a determination is made as to whether an incomplete files package exists. If it does, then the file is inserted into the incomplete package and the size, number of files, and last updated fields are updated. If the file has reached its optimal size range, or if the package must be delivered immediately, it is sent forward in the queue in step 742.

If the file is too big to be inserted into one package, it is broken up into parts in step 742 by the file transporter 220. Each part is put into one file's package. An incomplete file element is used to contain metadata describing which parts of the large file are in the package. The binary version of the encrypted file is inserted into the binary payload portion of the file entity in step 742. After breaking up the file in step 742, it proceeds to step 744, package file for transport. All steps relating to the creation of XML structure also relate to preparing headers, and combining headers in step 746.

In step 750 once a package is created, it is stored locally the file transporter 220.

After the file has been packaged, the package is cached in step 750 by the file transporter 220. In step 732 the local file manager 210 deletes the original copy of the file from the disk. The corresponding database record related to the local cache is also deleted.

Steps 752, 754 and 756 specify the actual transmission of the files package to the next node of the network or to the data vault server. In step 752, each time a file is ready to be sent, a send file event is triggered. This can occur in response to detection of trigger conditions including, for example, when a package is complete, when a deadline passes, a timer expires in the application, or when a component is first instantiated and it announces its availability to the network. This is achieved, for example, using a primitive poll invoked by a Java sleep process on a thread. According to one embodiment of the invention, to avoid recursion, the poll is not invoked if a process is already working. Typical systems do not deploy such a guard feature which often leads to bugs and performance problems when the system becomes busy.

In step 754 the file packages are encrypted, and in step 756, they are sent. According to one embodiment, the entire package is encrypted using SSL. SSL encryption uses a different key to that used when encrypting the original files.

In step 762 the next node of the network receives the package and sends an acknowledgment that the transaction is now complete. In step 758, the acknowledgement of the receipt of the package is received, and local file manager 210, proceeds to step 760 where it deletes the acknowledged file packages.

FIG. 8 is a conceptual layout diagram of an application information repository 126 according to one embodiment of the invention. At the top of the information hierarchy illustrated in FIG. 8 is an application vendor 810. The application vendor 810 may be a commercial vendor of applications or, in the case of a proprietary application, may be the customer.

Each application 812 has at least one application version 814 and each application version 814 is associated with at least one computer process 816. These computer processes 816 are associated with the files that they produce via a set of global backup rules 818, one per computer process. For example the application vendor 810 may be Microsoft, the application 812 may be Microsoft Office, the application version 814 may be version 7, the computer process 816 may be winword.exe, and the default global backup rule 818 may be “if app=MicrosoftOffice then BackupFlag=2,” which signals that the file should be backed up.

FIG. 9 is a conceptual layout diagram of the business rules repository 128 according to one embodiment of the invention. At the top of the information hierarchy illustrated in FIG. 9 is the customer 910 of the software product. Below the customer 910 are five elements that mimic the structure from the application information hierarchy 126. Below the customer 910 is at least one application vendor 912. The application vendor 912 can be a commercial vendor of applications or it can be the name of the customer itself in the case of proprietary applications.

Each application 914 belonging to an application vendor 912 has at least one application version 916. Each application version 916 is associated with at least one computer process 918. These computer processes 918 are associated with the files that they produce via a set of global backup rules 918, one per computer process For example, the application vendor 912 may be Microsoft, the application 914 may be Microsoft Office, the application version 916 may be version 7, the computer process 918 may be winword.exe, and the default global backup rule 920 may be “if app=MicrosoftOffice then BackupFlag=2,” which signals that the file should be backed up.

According to one embodiment of the invention, the customer may choose to override the default global back up rules 920 and substitute their own custom back up rules 922.

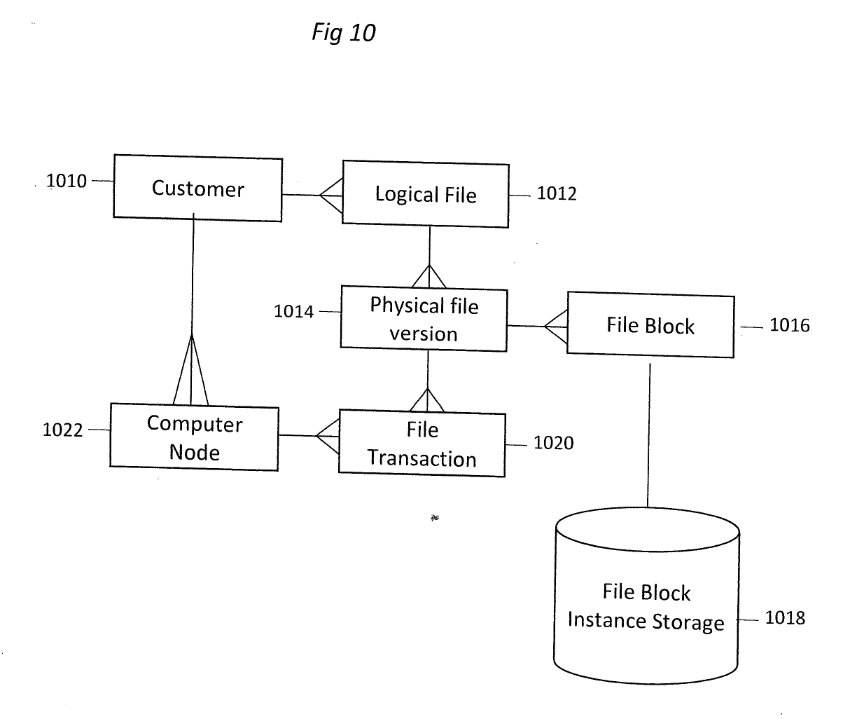

FIG. 10 is a conceptual layout diagram of the metadata storage vault 136 according to one embodiment of the invention. According to the illustrated embodiment, the four organizing principles behind the file metadata repository are logical files 1012, computer nodes 1022, customers 1010, and file blocks 1016. Logical files 1012 are stored by customers 1010 who also have a collection of computer nodes 1022 in which files are stored. The computer nodes 1022 may be similar to the computer(s) 260, 262 in FIG. 2. Each time a file change occurs on a computer node 1022, a file transaction 1020 takes place. This is true if metadata such as file owner, security, or file name changes, or if the content of the file itself actually changes. In one embodiment of the invention, the file transaction 1022 table stores information such as owner, path, last updated date/time, and the like.

Once a change is detected, if the bits composing the content change, a check sum value consisting of two standard hash algorithms combined with the size of the file is used to ascertain if a copy of these bits exist in the file storage vault 124. If a copy of these bits do not exist in the file storage vault, a new physical file version 1014 is generated, and a record of this event is stored in the new file version table. If up until now no file of that name at that path exists, a logical file record 1012 is also created. This is an organizing principle that is an abstraction residing even above the file version 1014. Thus, if the same check sum, or the same path exist for a file, it is deemed to be an instance of a logical file that may have many versions.

Once a determination is made that a new file version exists given that no duplicates of the check sum exists in the system, the file, if it is big enough, is broken down into chunks or blocks. Each block is then given a check sum of its own. In one embodiment of the invention, only those new blocks are then stored in a file block instance 1018 storage. According to one embodiment of the invention, this is the one and only place a physical copy of the file is stored. This allows for the absolute minimum of physical storage to take place, and for files to be restored to their state by reassembling the blocks that compose a version of a file in their right order. Therefore, in one embodiment of the invention, the metadata table has pointers to the file storage vault 124. According to one embodiment, the file storage vault is not aware of the metadata, but the metadata is aware of each particle of data in the file storage vault. In one embodiment of the invention, there is a many to many relationship between each record that represents a block of storage, and the files that represent the file versions.

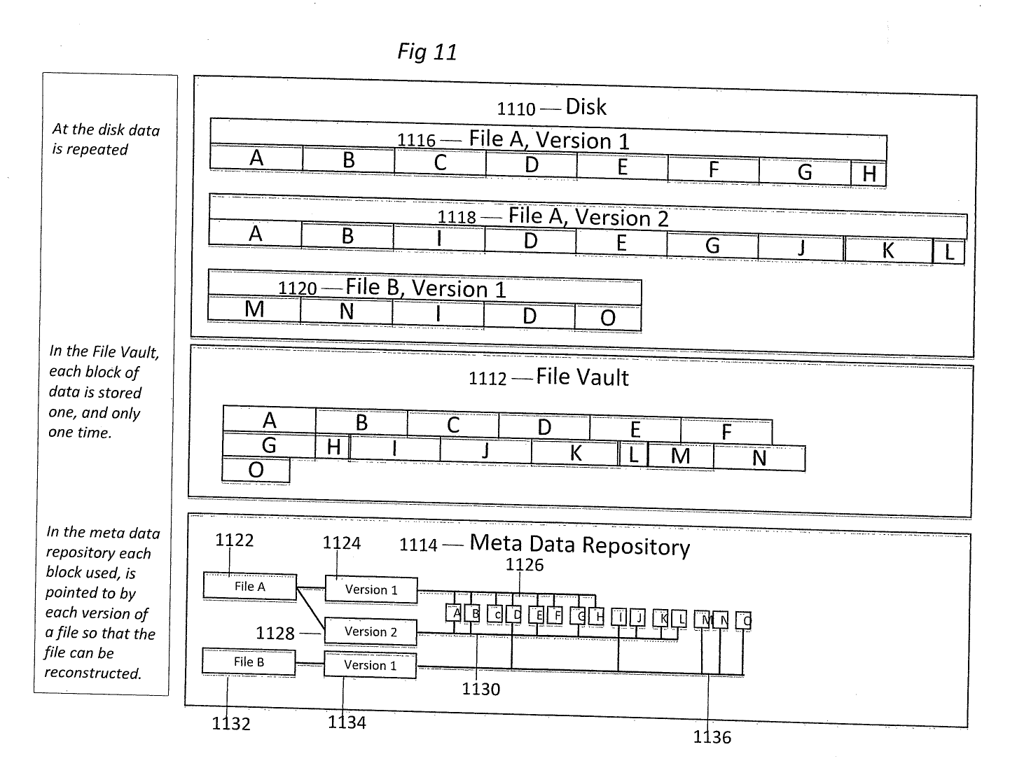

FIG. 11 is a conceptual layout diagram, according to one embodiment of the invention, of how file data is stored on the source disk 1110 and the file vault 1112 and how file versions are referenced and reconstructed using the metadata repository 1114. The file vault 1112 and metadata repository may be similar to the file storage vault 124 and the metadata storage vault 136 of FIG. 2

According to one embodiment of the present invention, the file blocks of files to be backed up exist in potentially two places, namely, the source disks 1110 of the customer, and, after backup, in the file vault 1112. Furthermore, references to the files and their various versions are contained in the metadata repository 1114 and are used to reconstruct files for recovery. According to one embodiment, files are not copied en masse from the source disks 1110 to the file vault 1112. Rather, files on the source disks 1110 are parsed and identified by the system as being composed of blocks as described above in with reference to FIG. 10. It is these individual file blocks that are persisted into the file vault 1112. Furthermore before a file is backed up, a reference to a file 1122 and its version 1124 are created in the metadata repository 1114, and references 1124 to each file block saved in the file vault 1112 are made in the metadata repository 1114.

In the example illustrated in FIG. 11, there are 3 files on the source disk 1110. These are File A, Version 1 1116, File A, Version 2 1118, and File B, Version 1 1120. Each file in turn is broken up into file blocks labeled A, B, C, etc. File A, Version 1 1116 and File A, Version 2 1118 both contain the file blocks labeled A, B, D, E and G. However, in the file vault 1112, these file blocks are stored only once and not twice. This helps eliminate redundant transmission of file blocks and their redundant storage. Further, for each of these files there are some blocks that are unique to each version. For example, blocks C and H for File A, Version 1 1120, and blocks I, J, K and L for File A, Version 2 1118, are unique. These blocks are stored once in the file vault. An unrelated file such as File B, Version 1 1120 may have file blocks in common, such as block D, with another file. Such blocks are also only stored once. What allows these savings in storage is that the metadata repository 1114 keeps track of each file, file version, and file blocks. For the three example files depicted in FIG. 11, the metadata repository 1114 includes:

A reference for File A 1122, a reference for File A, Version 1 1124, and block references 1126 to the file vault to all to the blocks contained in File A, Version 1

A reference for File A, Version 2 1128 and block references 1130 to the file vault to all to the blocks contained in File A, Version 2

A reference for File B 1132, a reference for File B, Version 1 1134 and block references 1136 to the file vault to all to the blocks contained in File B, Version 1

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A computer-implemented method for data backup and recovery across a data communications network, the method comprising:
detecting a file change for a file;
identifying a computer application producing the file change;
retrieving from a rule repository one or more backup rules stored in association with the identified computer application;
determining, based on the retrieved backup rules, whether the file change, or information about the change, should be stored in a backup repository; and
transmitting the file change over the data communications network in response to determining that the file change should be stored.

2. The method of claim 1, wherein the file change is a change of file metadata.

3. The method of claim 1, wherein the file change is a change to payload contents of the file.

4. The method of claim 1, wherein the detecting of the file change is in real-time with generating the file change.

5. The method of claim 4, wherein the identifying of the computer application producing the file change includes:
identifying a process identifier of a computer process producing the file change; and
mapping the process identifier to the computer application.

6. The method of claim 1, wherein the detecting the file change includes:
periodically scanning a data storage device storing the file; and
identifying change in metadata or content for the file.

7. The method of claim 6, wherein the identifying of the computer application producing the file change includes:
comparing at least a path of the file to a rule associating the file to a particular application.

8. The method of claim 1, wherein the determining whether the file change should be stored in the backup repository includes:
identifying one or more backup criteria from the retrieved backup rules;
determining whether the backup criteria have been satisfied.

9. The method of claim 1, wherein the determining whether the file change should be stored in the backup repository includes:
generating a hash value of a block of data contained in the file;
determining based on the generated hash value whether the block of data in the file differs from a corresponding block of data stored in the backup repository; and
identifying the block of data in the file if the block of data differs from the corresponding block of data in the backup repository.

10. The method of claim 1, wherein the transmitting the file change includes transmitting a block of data in the file containing the file change without transmitting a block of data in the file with no file changes.

11. The method of claim 1 further comprising:
receiving a user command to restore systems of files;
identifying a computer device into which the systems of files are to be restored; and
restoring the files onto the identified computer device.

12. The method of claim 11, wherein the restoring an individual one of the systems of files includes:
identifying one or more blocks of data associated with the file from the backup repository;
retrieving each of the one or more blocks of data from the remote backup repository;
re-creating the file based on the retrieved one or more blocks of data; and
storing the re-created filed in the identified computer device.

13. The method of claim 1 further comprising:
monitoring a plurality of file events;
discovering a plurality of computer applications associated with the monitored file events; and
compiling a set of default backup rules in the rule repository based on the discovered computer applications.

14. The method of claim 13, wherein the compiling of the set of default backup rules includes:
identifying a usage domain for the plurality of computer applications; and
selecting the set of default backup rules based on the identified usage domain.

15. The method of claim 13 further comprising:
generating a set of customized backup rules; and
storing the set of customized backup rules in the rule repository.

16. The method of claim 15, wherein the retrieved backup rules are selected from the set of default backup rules and the customized backup rules.

17. A computer apparatus for data backup and recovery across a data communications network comprising:
a processor; and
a memory operably coupled to the processor and storing program instructions therein, the processor being operable to execute the program instructions, the program instructions including:
detecting a file change for a file;
identifying a computer application producing the file change;
retrieving from a rule repository one or more backup rules stored in association with the identified computer application;
determining, based on the retrieved backup rules, whether the file change should be stored in a backup repository; and
transmitting the file change over the data communications network in response to determining that the file change should be stored.

18. The apparatus of claim 17, wherein the file change is a change of file metadata.

19. The apparatus of claim 17, wherein the file change is a change to payload contents of the file.

20. The apparatus of claim 17, wherein the detecting of the file change is in real-time with generating the file change.

21. The apparatus of claim 20, wherein the computer instructions for identifying of the computer application producing the file change includes computer instructions for:
identifying a process identifier of a computer process producing the file change; and
mapping the process identifier to the computer application.

22. The apparatus of claim 17, wherein the computer instructions for detecting the file change includes:
periodically scanning a data storage device storing the file; and
identifying change in content or metadata for the file.

23. The apparatus of claim 22, wherein the computer instructions for identifying the computer application producing the file change includes computer instructions for:
comparing at least a path of the file to a rule associating the file to a particular application.

24. The apparatus of claim 17, wherein the computer instructions for determining whether the file change should be stored in the backup repository includes computer instructions for:
identifying one or more backup criteria from the retrieved backup rules;
determining whether the backup criteria have been satisfied.

25. The apparatus of claim 17, wherein the computer instructions for determining whether the file change should be stored in the backup repository includes computer instructions for:
generating a hash value of a block of data contained in the file;
determining based on the generated hash value whether the block of data in the file differs from a corresponding block of data stored in the backup repository; and
identifying the block of data in the file if the block of data differs from the corresponding block of data in the backup repository.

26. The apparatus of claim 17, wherein the transmitting the file change includes transmitting a block of data in the file containing the file change without transmitting a block of data in the file with no file changes.

27. The apparatus of claim 17, wherein the computer instructions further include:
receiving a user command to restore systems of files;
identifying a computer device into which the files are to be restored; and
restoring the files onto the identified computer device.

28. The apparatus of claim 27, wherein the computer instructions for restoring an individual one of the the files further include computer instructions for:
identifying one or more blocks of data associated with the file from the backup repository;
retrieving each of the one or more blocks of data from the remote backup repository;
re-creating the file based on the retrieved one or more blocks of data; and
storing the re-created filed in the identified computer device.

29. The apparatus of claim 17, wherein the computer instructions further include:
monitoring a plurality of file events;
discovering a plurality of computer applications associated with the monitored file events; and
compiling a set of default backup rules in the rule repository based on the discovered computer applications.

30. The apparatus of claim 29, wherein the computer instructions for compiling the set of default backup rules further include computer instructions for:
identifying a usage domain for the plurality of computer applications; and
selecting the set of default backup rules based on the identified usage domain.

31. The apparatus of claim 29, wherein the computer instructions further include:
generating a set of customized backup rules; and
storing the set of customized backup rules in the rule repository.

32. The apparatus of claim 29, wherein the retrieved backup rules are selected from the set of default backup rules and the customized backup rules.
